(19) United States
(12) Patent Application Publication
(10) Pub. No.: US 2024/0026092 A1
(43) Pub. Date: Jan. 25, 2024

(54) METHOD FOR PRODUCING PURIFIED POLYMER FINE PARTICLES AND METHOD FOR PRODUCING RESIN COMPOSITION

(71) Applicant: KANEKA CORPORATION, Osaka (JP)

(72) Inventor: Nobuyoshi Maizuru, Hyogo (JP)

(73) Assignee: KANEKA CORPORATION, Osaka (JP)

(21) Appl. No.: 18/374,971

(22) Filed: Sep. 29, 2023

Related U.S. Application Data
(63) Continuation of application No. PCT/JP2022/015432, filed on Mar. 29, 2022.

(30) Foreign Application Priority Data
Mar. 31, 2021 (JP) 2021-061526

(51) Int. Cl. C08J 3/16; C08F 6/22; C08F 6/16; C08F 279/06; C08L 63/00

(52) U.S. Cl. CPC C08J 3/16; C08F 6/22; C08F 6/16; C08F 279/06; C08L 63/00; C08J 2351/04; C08L 2201/52; C08L 2205/22

(57) ABSTRACT

A method for producing purified fine polymer particles (A), includes an organic solvent mixing step of mixing an organic solvent (B) and a latex that contains fine polymer particles (A) and an emulsifying agent having a polyethylene group to obtain a mixture, and a mixed state maintaining step of allowing the mixture to stand and/or stirring the mixture. The method can efficiently purify fine polymer particles from a latex and has reduced environmental impact.

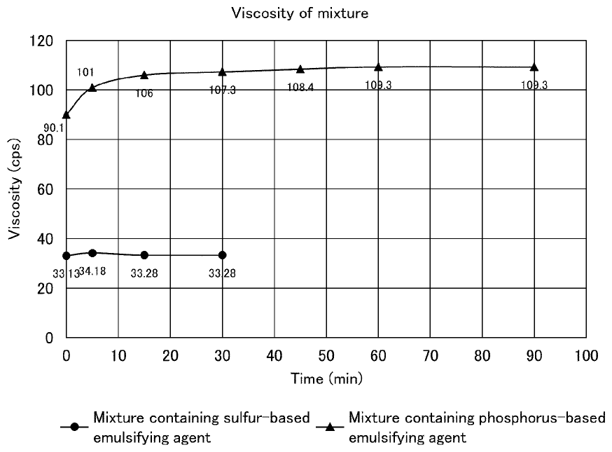

### TECHNICAL FIELD

One or more embodiments of the present invention relate to a method for producing purified fine polymer particles and method for producing a resin composition.

### BACKGROUND

Thermosetting resins have various kinds of excellent properties such as high heat resistance and high mechanical strength, and therefore are used in various fields. Out of the thermosetting resins, epoxy resins are used as matrix resins in a wide variety of applications such as, for example, sealants for electronic circuits, paints, adhesives, and fiber-reinforced materials. The epoxy resins have excellent heat resistance, chemical resistance, insulating properties, and the like, but are insufficient in impact resistance which is a characteristic of thermosetting resins. One widely used method to improve the impact resistance of a thermosetting resin is to add an elastomer to the thermosetting resin.

Examples of the elastomer encompass fine polymer particles (for example, fine crosslinked polymer particles). The fine polymer particles may generally have a particle size of less than 1 μm. It should be noted here that a powdery and/or granular material of fine polymer particles prepared by collecting several primary particles of the fine polymer particles, each of which has a particle size of less than 1 μm, will be referred to as secondary particles. It is possible to disperse secondary particles of the fine polymer particles in a thermosetting resin. However, it is extremely difficult, at an industrial level, to disperse primary particles of the fine polymer particles in a thermosetting resin.

As a method for producing a resin mixture in which primary particles of fine polymer particles are dispersed in a thermosetting resin, Patent Literature 1 discloses a method for mixing, with a thermosetting resin, purified fine polymer particles obtained by removing, from a latex containing the fine polymer particle, water and impurities (such as an emulsifying agent). According to the disclosure in Patent Literature 1, an agglutinate of the fine polymer particles is obtained by mixing, with an organic solvent, a latex containing the fine polymer particles and then causing the resultant mixture to come into contact with water. By separating the resultant agglutinate from an aqueous phase containing the impurities, purified fine polymer particles with reduced impurities are obtained.

### PATENT LITERATURE

[Patent Literature 1]
PCT International Publication No. WO2005/028546

However, the conventional technique as described above is not sufficient from the viewpoint of environmental impact, and has room for further improvements.

### SUMMARY

One or more embodiments of the present invention have been made in view of the above, and provide a novel method which can efficiently purify the fine polymer particles from a latex and which has reduced environmental impact.

As a result of conducting diligent research, the inventor of one or more embodiments of the present invention completed one or more embodiments of the present invention.

A purified fine polymer particle (A) production method in accordance with one or more embodiments of the present invention includes: an organic solvent mixing step of mixing an organic solvent (B) and a latex that contains fine polymer particles (A) and an emulsifying agent; and a mixed state maintaining step of performing at least one selected from the group consisting of allowing a mixture obtained in the organic solvent mixing step to stand and stirring the mixture, in which the emulsifying agent contains a lipophilic part and a hydrophilic part, and the hydrophilic part has a polyoxyethylene group.

A purified fine polymer particle (A) production method in accordance with one or more embodiments of the present invention includes: an organic solvent mixing step of mixing an organic solvent (B) and a latex that contains fine polymer particles (A) and an emulsifying agent; a loose agglutinating step of causing a mixture obtained in the organic solvent mixing step to come into contact with water so as to produce, in an aqueous phase, an agglutinate of the fine polymer particles (A) which agglutinate contains the organic solvent (B); and a separating step of separating the agglutinate from the aqueous phase, in which the method further includes a step of repeating a cycle selected from (i) and (ii) below at least once after the separating step.

(i) A first cycle including a first step of adding the organic solvent (B) to the agglutinate obtained in the separating step, a second step of causing a mixture obtained in the first step to come into contact with water so as to produce, in an aqueous phase, an agglutinate of the fine polymer particles (A) which agglutinate contains the organic solvent (B), and a third step of separating, from the aqueous phase, the agglutinate obtained in the second step; and

(ii) a second cycle including a first step of adding water to the agglutinate obtained in the separating step, a second step of causing a mixture obtained in the first step to come into contact with the organic solvent (B) so as to produce, in an aqueous phase, an agglutinate of the fine polymer particles (A) which agglutinate contains the organic solvent (B), and a third step of separating, from the aqueous phase, the agglutinate obtained in the second step.

With an aspect of one or more embodiments of the present invention, it is possible to provide a novel method which can efficiently purify fine polymer particles from a latex and which has reduced environmental impact.

### BRIEF DESCRIPTION OF THE DRAWINGS

The FIGURE is a graph that shows changes over time in the viscosity of a mixture of an organic solvent and a latex which contains a phosphorus-based emulsifying agent having a polyoxyethylene group or a sulfur-based emulsifying agent having no polyoxyethylene group.

### DETAILED DESCRIPTION

The following description will discuss embodiments of the present invention. One or more embodiments of the present invention are not, however, limited to these embodiments. One or more embodiments of the present invention are not limited to the configurations described below, but may be altered in various ways within the scope of the claims. One or more embodiments of the present invention also encompass, in their technical scope, any embodiments or Example derived by combining technical means disclosed in differing embodiments and Examples. Further, it is possible to form a new technical feature by combining the technical means disclosed in the respective embodiments. All academic and patent documents cited in the present specification are incorporated herein by reference. Any numerical range expressed as “A to B” in the present specification means “not less than A and not more than B (i.e., a range from A to B which includes both A and B)” unless otherwise stated.

### Embodiment 1

[1-1. Technical Idea of One or More Embodiments of the Present Invention]

In recent years, from the viewpoint of environmental conservation, there have been attempts to replace materials having a larger environmental impact with materials having a smaller environmental impact. A straight-chain alkyl benzene sulfonate (LAS) is widely used as an emulsifying agent used in the production of the fine polymer particles, from the viewpoint of, for example, polymerization stability, cost, availability, and neutral pH. However, emulsifying agents having straight-chain alkyl benzenes are less decomposable and have a large environmental impact. Therefore, it is preferable from the viewpoint of environmental conservation to use an emulsifying agent having a polyoxyethylene group having an ether bond which is easily decomposed by an organism. Therefore, with use of an emulsifying agent having a polyoxyethylene group instead of an emulsifying agent having straight-chain alkyl benzene, an attempt was made to purify fine polymer particles (A) from a latex containing the prepared fine polymer particles (A) in accordance with the method disclosed in Patent Literature 1. As a result, an aqueous phase (a liquid discharged after an agglutinate of the fine polymer particles (A) has been separated) obtained by causing a mixture of the latex and an organic solvent (B) to come into contact with water unfortunately became white and turbid. The investigation of the cause of the white turbidity of the aqueous phase revealed that a non-agglutinated content of the fine polymer particles (A) had been mixed in the aqueous phase.

Therefore, as a result of diligent research by the inventor of one or more embodiments of the present invention, the following new finding was made and one or more embodiments of the present invention were thus completed: After an organic solvent mixing step of mixing a latex and an organic solvent (B) and before a loose agglutinating step of causing the mixture to come into contact with water to produce an agglutinate, providing a step of allowing the mixture to stand and/or stirring the mixture for a certain period of time can resolve white turbidity in a discharged liquid.

Furthermore, the inventor of one or more embodiments of the present invention investigated the cause behind the resolution of the white turbidity of a discharged liquid as a result of allowing the mixture to stand and/or stirring the mixture for a certain period of time, and independently discovered knowledge below.

(i) In the latex, the fine polymer particles (A) and the emulsifying agent are present in the solvent (latex solvent) in a state in which the fine polymer particles (A) and the emulsifying agent are bonding to each other. When the latex is mixed with an organic solvent (B), the emulsifying agent moves to the interface between the latex solvent and the organic solvent (B), and thus the dissociation of the bonding of the fine polymer particles (A) and the emulsifying agent occurs. This causes the fine polymer particles (A) to move from the latex solvent into the organic solvent (B). When such a mixture is brought into contact with water, the fine polymer particles (A) form an agglutinate. The formed agglutinate can be separated from the aqueous phase by a separation means.

(ii) However, when an emulsifying agent having a polyoxyethylene group is used as the emulsifying agent, it takes longer for the fine polymer particles (A) to move into the organic solvent (B) in comparison with a case where an emulsifying agent having a straight-chain alkyl benzene is used as the emulsifying agent. The reason for this is unclear, but it is inferred that because the emulsifying agent having a polyoxyethylene group has higher affinity with (a) the fine polymer particles (A) in comparison with an emulsifying agent having a straight-chain alkyl benzene, it takes a longer period of time for the dissociation of the bonding of the fine polymer particles (A) and the emulsifying agent to occur. It should be noted that one or more embodiments of the present invention are not limited to such an inference. When the mixture of the latex and the organic solvent (B) is brought into contact with water before the fine polymer particles (A) complete moving into the organic solvent (B), part of fine polymer particles (A) cannot form an agglutinate and cannot be separated from the aqueous phase. Therefore, the aqueous phase (discharged liquid) become white and turbid.

(iii) A step of allowing the mixture of the latex and the organic solvent (B) to stand and/or stirring the mixture (the mixed state maintaining step in the first production method) promotes the dissociation of the bonding of the fine polymer particles (A) and the emulsifying agent and promotes the movement of the fine polymer particles (A) into an organic solvent (B). This increases the viscosity of the mixture. After sufficient movement of the fine polymer particles (A) into the organic solvent (B), that is, when the mixture and water are brought into contact with each other after the viscosity of the mixture is constant, the fine polymer particles (A) can sufficiently agglutinate. Therefore, it is possible to prevent white turbidity of the discharged liquid caused by mixing of non-agglutinated fine polymer particles (A).

[1-2. Purified Fine Polymer Particle (A) Production Method (First Production Method)]

A purified fine polymer particle (A) production method in accordance with one or more embodiments of the present invention includes: an organic solvent mixing step of mixing an organic solvent (B) and a latex that contains fine polymer particles (A) and an emulsifying agent; and a mixed state maintaining step of performing at least one selected from the group consisting of allowing a mixture obtained in the organic solvent mixing step to stand and stirring the mixture. The emulsifying agent contains a lipophilic part and a hydrophilic part, and the hydrophilic part has a polyoxyethylene group.

In the present specification, it can also be said that the “purified fine polymer particle (A) production method” is a “method for purifying fine polymer particles (A)”. The purified fine polymer particle (A) production method in accordance with one or more embodiments of the present invention may also be referred to as “first production method”.

In the present specification, “allowing a mixture to stand” means to intentionally not apply impact such as a vibration and can also be said to “leave a mixture to stand”. In addition, in the present specification, “stirring” means to intentionally applying impact including a vibration, and the degree of the impact is not limited.

That is, in the present specification, because stirring means all cases other than allowing the mixture to stand, the state of the mixture falls under either “standing” or “being stirred”. In the present specification, “performing both of allowing the mixture to stand and stirring the mixture” means either (i) stirring is performed after the mixture has been allowed to stand or (ii) the mixture is allowed to stand after the mixture has been stirred. It should be noted that stirring may be continued from the organic solvent mixing step through the mixed state maintaining step.

In the first production method, an emulsifying agent having a polyoxyethylene group is used. Therefore, the first production method has an advantage of causing environmental impact less in comparison with the conventional technique in which an emulsifying agent having straight-chain alkyl benzene is used. According to the first production method, it is possible to efficiently produce purified fine polymer particles (A) from a latex containing fine polymer particles (A) prepared with use of an emulsifying agent having a polyoxyethylene group whose environmental impact is small. In addition, the purified fine polymer particles (A) obtained by the first production method has an advantage of containing a smaller amount of impurities such as an emulsifying agent, more specifically, a smaller amount of phosphorus (P) and sulfur (S) derived from the emulsifying agent. Furthermore, the discharged liquid produced by the implementation of the first production method contains extremely few fine polymer particles (A) mixed in, that is, the first production method has an advantage of having excellent production efficiency.

First, the raw material (component) used in the first production method will be described, and then each step will be described.

(1-2-1. Latex)

In the present specification, the term “latex” is intended to mean a solution which contains a solvent, the fine polymer particles (A), and an emulsifying agent and in which the fine polymer particles (A) and the emulsifying agent are present in such a manner as to be dispersed in the solvent. The “latex” can also be referred to as a “suspension of fine polymer particles (A)”. The solvent for the latex is not limited to any particular one, and examples thereof encompass water. A latex in which the solvent is water can also be called “aqueous latex” or can be referred to as an “aqueous suspension of fine polymer particles (A)”. In the solvent in the latex, the fine polymer particles (A) are preferably dispersed in the form of primary particles.

The latex containing the fine polymer particles (A) and the emulsifying agent can be produced by a known method, for example, an emulsion polymerization method for the fine polymer particles (A) and a method for suspending the fine polymer particles (A) and the emulsifying agent in a solvent. The emulsion polymerization method for the fine polymer particles (A) is described later in detail in the section (2-3. Fine polymer particle (A) production method).

(1-2-2. Fine Polymer Particles (A))

Provided that the fine polymer particles (A) are fine polymer particles obtained by polymerization, other aspects of the fine polymer particles (A) are not particularly limited.

(Graft Part)

The fine polymer particles (A) preferably have a graft part. In the present specification, a “graft part” is intended to mean a polymer grafted to any polymer. The fine polymer particles (A) having a graft part can also be referred to as a graft copolymer. That is, the fine polymer particles (A) are preferably a graft copolymer. When the fine polymer particles (A) are a graft copolymer, there is an advantage that the fine polymer particles (A) can exhibit a suitable behavior in the first production method and in a resin composition production method described later.

The graft part preferably is (contains) a polymer that contains, as one or more structural units, one or more structural units derived from at least one type of monomer selected from the group consisting of aromatic vinyl monomers, vinyl cyanide monomers, and (meth)acrylate monomers. The graft part having the above feature can play various roles. The “various roles” are, for example, (i) improving compatibility between the fine polymer particles (A) and the resin (D) which is a matrix resin in the resin composition, (ii) improving the dispersibility of the fine polymer particles (A) in the resin (D), and (iii) allowing the fine polymer particles (A) to be dispersed in the form of primary particles in the resin composition or in a cured product obtained from the resin composition.

Specific examples of the aromatic vinyl monomers encompass styrene, α-methylstyrene, p-methylstyrene, and divinylbenzene.

Specific examples of the vinyl cyanide monomers encompass acrylonitrile and methacrylonitrile.

Specific examples of the (meth)acrylate monomers encompass methyl (meth)acrylate, ethyl (meth)acrylate, butyl (meth)acrylate, hydroxyethyl (meth)acrylate, and hydroxybutyl (meth)acrylate. In the present specification, (meth)acrylate is intended to mean acrylate and/or methacrylate.

The at least one type of monomer selected from the group consisting of aromatic vinyl monomers, vinyl cyanide monomers, and (meth)acrylate monomers may be used alone or in combination of two or more.

The graft part contains a structural unit derived from an aromatic vinyl monomer, a structural unit derived from a vinyl cyanide monomer, and a structural unit derived from a (meth)acrylate monomer, together in an amount of preferably 10% by weight to 95% by weight, more preferably 30% by weight to 92% by weight, even more preferably 50% by weight to 90% by weight, particularly preferably 60% by weight to 87% by weight, most preferably 70% by weight to 85% by weight, with respect to 100% by weight of the graft part.

The graft part preferably contains, as a structural unit, a structural unit derived from a monomer having a reactive group. The monomer having a reactive group is preferably a monomer having at least one type of reactive group selected from the group consisting of epoxy group, oxetane group, hydroxy group, amino group, imide group, carboxylic acid group, carboxylic anhydride group, cyclic ester, cyclic amide, benzoxazine group, and cyanate ester group, and is more preferably a monomer having at least one type of reactive group selected from the group consisting of epoxy group, hydroxy group, and carboxylic acid group, and is most preferably a monomer having epoxy group. This feature makes it possible to allow the graft part of the fine polymer particles (A) and the resin (D) (such as a thermosetting resin) to be chemically bonded to each other in the resin composition. Thus, in the resin composition or in a cured product obtained from the resin composition, it is possible to maintain a favorable state of dispersion of the fine polymer particles (A) without causing the fine polymer particles (A) to agglutinate.

Specific examples of the monomer having epoxy group encompass glycidyl-group-containing vinyl monomers such as glycidyl (meth)acrylates, 4-hydroxybutyl (meth)acrylate glycidyl ethers, and allyl glycidyl ethers.

Specific examples of the monomer having hydroxy group encompass (i) hydroxy straight-chain alkyl (meth)acrylates (in particular, hydroxy straight chain C1-C6 alkyl(meth)acrylates) such as 2-hydroxyethyl (meth)acrylates, hydroxypropyl (meth)acrylates, and 4-hydroxybutyl (meth)acrylates, (ii) caprolactone-modified hydroxy (meth)acrylates, (iii) hydroxy branching alkyl (meth)acrylates such as α-(hydroxymethyl) methyl acrylates and α-(hydroxymethyl) ethyl acrylates, and (iv) hydroxyl-group-containing (meth)acrylates such as mono (meth)acrylates of a polyester diol (particularly saturated polyester diol) obtained from a dicarboxylic acid (e.g., phthalic acid) and a dihydric alcohol (e.g., propylene glycol).

Specific examples of a monomer having a carboxylic acid group encompass monocarboxylic acids such as acrylic acid, methacrylic acid, and crotonic acid. Other examples of the monomer encompass dicarboxylic acids such as maleic acid, fumaric acid, and itaconic acid. Any of the monocarboxylic acids is suitably used as the monomer having carboxylic acid group.

These monomers having reactive group(s) may be used alone or in combination of two or more.

The graft part contains structural unit(s) derived from monomer(s) having reactive group(s) in an amount of preferably 0.5% by weight to 90% by weight, more preferably 1% by weight to 50% by weight, even more preferably 2% by weight to 35% by weight, particularly preferably 3% by weight to 20% by weight, with respect to 100% by weight of the graft part. In a case where the graft part contains the structural unit derived from the monomer(s) having the reactive group(s) in an amount of not less than 0.5% by weight with respect to 100% by weight of the graft part, the resin composition to be obtained can provide a cured product which has enough impact resistance. In a case where the graft part contains the structural unit derived from the reactive group-containing monomer in an amount of not more than 90% by weight with respect to 100% by weight of the graft part, the resin composition to be obtained has advantages that (a) the resin composition can provide a cured product which has sufficient impact resistance and (b) the resin composition has favorable storage stability.

The structural unit(s) derived from the monomer(s) having reactive group(s) is preferably contained in the graft part, and more preferably contained only in the graft part.

The graft part may contain, as a structural unit, a structural unit derived from a polyfunctional monomer. In a case where the graft part contains the structural unit derived from the polyfunctional monomer, there are the following advantages, for example: (i) it is possible to prevent swelling of the fine polymer particles (A) in the resin composition; (ii) since the resin composition has a low viscosity, the resin composition tends to have favorable handleability; and (iii) the dispersibility of the fine polymer particles (A) in the resin (D) (such as a thermosetting resin) is improved.

In a case where the graft part does not contain the structural unit derived from the polyfunctional monomer, the resin composition to be obtained can provide a cured product which has more excellent toughness and impact resistance, as compared to a case where the graft part contains the structural unit derived from the polyfunctional monomer.

It can also be said that the polyfunctional monomer is a monomer having two or more radical-polymerizable reactive groups in an identical molecule. The radical-polymerizable reactive groups are each preferably a carbon-carbon double bond. Examples of the polyfunctional monomer exclude butadiene and encompass (meth)acrylates having an ethylenically unsaturated double bond(s), such as allyl alkyl (meth)acrylates and allyl oxyalkyl (meth)acrylates. Examples of a monomer having two (meth)acrylic groups encompass ethylene glycol di(meth)acrylate, butylene glycol di(meth)acrylate, butanediol di(meth)acrylate, hexanediol di(meth)acrylate, cyclohexane dimethanol di(meth)acrylate, and polyethylene glycol di(meth)acrylates. Examples of the polyethylene glycol di(meth)acrylates encompass triethylene glycol di(meth)acrylate, tripropylene glycol di(meth)acrylate, tetraethylene glycol di(meth)acrylate, and polyethylene glycol (600) di(meth)acrylate. Examples of a monomer having three (meth)acrylic groups encompass alkoxylated trimethylolpropane tri(meth)acrylates, glycerol propoxy tri(meth)acrylate, pentaerythritol tri(meth)acrylate, and tris(2-hydroxyethyl)isocyanurate tri(meth)acrylate. Examples of the alkoxylated trimethylolpropane tri(meth)acrylates encompass trimethylolpropane tri(meth)acrylate and trimethylolpropane triethoxy tri(meth)acrylate. Examples of a monomer having four (meth)acrylic groups encompass pentaerythritol tetra(meth)acrylate and ditrimethylolpropane tetra(meth)acrylate. Examples of a monomer having five (meth)acrylic groups encompass dipentaerythritol penta(meth)acrylate. Examples of a monomer having six (meth)acrylic groups encompass ditrimethylolpropane hexa(meth)acrylate. Examples of the polyfunctional monomer also encompass diallyl phthalate, triallyl cyanurate, triallyl isocyanurate, and divinylbenzene.

Out of the above polyfunctional monomers, examples of a polyfunctional monomer which can be preferably used to form the graft part by polymerization encompass allyl methacrylate, ethylene glycol di(meth)acrylate, butylene glycol di(meth)acrylate, butanediol di(meth)acrylate, hexanediol di(meth)acrylate, cyclohexane dimethanol di(meth)acrylate, and polyethylene glycol di(meth)acrylates. Such polyfunctional monomers may be used alone or in combination of two or more.

The graft part contains structural unit(s) derived from polyfunctional monomer(s) in an amount of preferably 1% by weight to 20% by weight, more preferably 5% by weight to 15% by weight, with respect to 100% by weight of the graft part.

In formation of the graft part by polymerization, the foregoing monomers may be used alone or in combination of two or more. The graft part may contain a structural unit derived from another monomer, in addition to the structural units derived from the above-listed monomers.

The graft part is preferably a polymer grafted to an elastic body (described later).

(Glass Transition Temperature of Graft Part)

The graft part has a glass transition temperature of preferably not higher than 190° C., more preferably not higher than 160° C., more preferably not higher than 140° C., more preferably not higher than 120° C., more preferably not higher than 80° C., more preferably not higher than 70° C., more preferably not higher than 60° C., more preferably not higher than 50° C., more preferably not higher than 40° C., more preferably not higher than 30° C., more preferably not higher than 20° C., more preferably not higher than 10° C., more preferably not higher than 0° C., more preferably not higher than −20° C., more preferably not higher than −40° C., more preferably not higher than −45° C., more preferably not higher than −50° C., more preferably not higher than −55° C., more preferably not higher than −60° C., more preferably not higher than −65° C., more preferably not higher than −70° C., more preferably not higher than −75° C., more preferably not higher than −80° C., more preferably not higher than −85° C., more preferably not higher than −90° C., more preferably not higher than −95° C., more preferably not higher than −100° C., more preferably not higher than −105° C., more preferably not higher than −110° C., more preferably not higher than −115° C., even more preferably not higher than −120° C., particularly preferably not higher than −125° C.

The glass transition temperature of the graft part is preferably not lower than 0° C., more preferably not lower than 30° C., more preferably not lower than 50° C., more preferably not lower than 70° C., even more preferably not lower than 90° C., particularly preferably not higher than 110° C.

The Tg of the graft part can be determined by, for example, the composition of the structural unit contained in the graft part. In other words, it is possible to adjust the Tg of the resulting graft part by changing the composition of the monomer used to produce (form by polymerization) the graft part.

The Tg of the graft part can be obtained by carrying out viscoelasticity measurement with use of a planar plate made of fine polymer particles (A). Specifically, the Tg can be measured as follows: (1) a graph of tan δ is obtained by carrying out dynamic viscoelasticity measurement with respect to a planar plate made of the fine polymer particles (A), with use of a dynamic viscoelasticity measurement device (for example, DVA-200, manufactured by IT Keisoku Seigyo Kabushikigaisha) under a tension condition; and (2) in the graph of tan δ thus obtained, the peak temperature of tan δ is regarded as the glass transition temperature. Note, here, that in a case where a plurality of peaks is found in the graph of tan δ, the highest peak temperature is regarded as the glass transition temperature of the graft part.

(Graft Rate of Graft Part)

In one or more embodiments of the present invention, the fine polymer particles (A) may have a polymer which is identical in composition to the graft part and which is not grafted to a polymer (e.g., elastic body described later). In the present specification, a “polymer that is identical in composition to the graft part but is not grafted to a polymer” may be referred to as “non-grafted polymer”. The non-grafted polymer constitutes a part of the fine polymer particles (A) in accordance with one or more embodiments of the present invention. It can also be said that the non-grafted polymer is a polymer that is not grafted to a polymer, out of polymers produced during formation of the graft part by polymerization.

In the present specification, the proportion of (i) a polymer which is grafted to a polymer to (ii) the polymers produced during the formation of the graft part by polymerization, i.e., the proportion of the graft part, is referred to as a “graft rate”. In other words, the graft rate is a value represented by the following expression: (weight of graft part)/{(weight of graft part)+(weight of non-grafted polymer)}×100.

The graft rate of the graft part is preferably not less than 70%, more preferably not less than 80%, even more preferably not less than 90%. In a case where the graft rate is not less than 70%, there is an advantage that the viscosity of the resin composition does not become too high.

In the present specification, the graft rate is calculated by the following method. First, an aqueous suspension containing the fine polymer particles (A) is obtained. Next, a powdery and/or granular material of the fine polymer particles (A) is obtained from the aqueous suspension. A specific example of a method for obtaining the powdery and/or granular material of the fine polymer particles (A) from the aqueous suspension is a method for obtaining the powdery and/or granular material of the fine polymer particles (A) by (i) causing the fine polymer particles (A) in the aqueous suspension to coagulate, (ii) dehydrating the coagulate thus obtained, and (iii) further drying the coagulate. Next, 2 g of the powdery and/or granular material of the fine polymer particles (A) is dissolved in 50 mL of methyl ethyl ketone (hereinafter also referred to as “MEK”). The MEK solution of the powder thus obtained is separated into a part soluble in MEK (MEK-soluble part) and a part insoluble in MEK (MEK-insoluble part). Specifically, the following (1) through (3) are carried out: (1) The obtained MEK solution of the powder is subjected to centrifugal separation with use of a centrifugal separator (CP60E, manufactured by Hitachi Koki Co., Ltd.) at a rotation speed of 30000 rpm for 1 hour, and thereby separated into the MEK-soluble part and the MEK-insoluble part. (2) The obtained MEK-soluble part and MEK are mixed. The resultant MEK mixture is subjected to centrifugal separation with use of the foregoing centrifugal separator at a rotation speed of 30000 rpm for 1 hour, and the MEK mixture is separated into the MEK-soluble part and the MEK-insoluble part. (3) The above operation (2) is repeated once (that is, the centrifugal separation is carried out three times total). The above operation produces a concentrated MEK-soluble part. Next, 20 ml of the concentrated MEK-soluble part is mixed with 200 ml of methanol. An aqueous calcium chloride solution in which 0.01 g of calcium chloride is dissolved in water is added to the obtained mixture, and the mixture thus obtained is stirred for 1 hour. After that, the obtained mixture is separated into a methanol-soluble part and a methanol-insoluble part. The weight of the methanol-insoluble part is used as the amount of a free polymer (FP).

The graft rate is calculated with use of the following formula.

Graft rate (%)=100−[(amount of FP)/{(amount of FP)+(weight of MEK-insoluble part)}]/(weight of polymer of graft part)×10000

Note that the weight of a polymer other than the graft part is the amount of monomer introduced for formation of the polymer other than the graft part. The polymer other than the graft part is, for example, the elastic body. In a case where the fine polymer particles (A) contain a surface-crosslinked polymer (described later), the polymer other than the graft part includes both the elastic body and the surface-crosslinked polymer. The weight of the polymer of the graft part is the amount of monomer introduced for formation of the polymer of the graft part. In calculation of the graft rate, a method for causing the fine polymer particles (A) to coagulate is not limited to any particular one, and a method in which a solvent is used, a method in which a coagulant is used, a method in which the aqueous suspension is sprayed, or the like can be employed.

(Variations of Graft Part)

In one or more embodiments of the present invention, the graft part may be constituted by only one type of graft part which has a structural unit having identical composition. In one or more embodiments of the present invention, the graft part may be constituted by a plurality of types of graft parts which have structural units different from each other in composition.

A case where the graft part is constituted by a plurality of types of graft parts in one or more embodiments of the present invention will be described. In this case, the plurality of types of graft parts will be referred to as a graft part₁, a graft part₂, . . . a graft partₙ (“n” is an integer of 2 or more). The graft part may include a complex of the graft part₁, the graft part₂ . . . , and the graft partₙ which are individually formed by polymerization. The graft part may include a polymer obtained by forming the graft part₁, the graft part₂, . . . , and the graft partₙ in order by polymerization. Forming a plurality of polymerized parts (graft parts) by polymerization in order in this manner is also referred to as multistage polymerization. A polymer obtained by multistage polymerization of a plurality of types of graft parts is also referred to as a multistage-polymerization graft part. A method for producing a multistage-polymerization graft part will be later described in detail.

In a case where the graft part is constituted by the plurality of types of graft parts, all of the plurality of types of graft parts do not need to be grafted to the elastic body. It is only necessary that at least part of at least one of the plurality of types of graft parts be grafted to the elastic body. The other of the plurality of types of graft parts (the other types of graft parts) may be grafted to the at least one of the plurality of types of graft parts which is grafted to the elastic body. In a case where the graft part is constituted by the plurality of types of graft parts, the graft part may have a plurality of types of polymers which are identical in composition to the plurality of types of graft parts and which are not grafted to the elastic body (a plurality of types of non-grafted polymers).

The multistage-polymerization graft part constituted by the graft part₁, the graft part₂, . . . the graft partₙ will be described. In the multistage-polymerization graft part, the graft partₙ can cover at least part of a graft partₙ₋₁ or the whole of the graft partₙ₋₁. In the multistage-polymerization graft part, part of the graft partₙ may be located inside the graft partₙ₋₁.

In the multistage-polymerization graft part, the graft parts may form a layer structure. For example, in a case where the multistage-polymerization graft part is constituted by the graft part₁, the graft part₂, and a graft part₃, aspects of one or more embodiments of the present invention also include an aspect in which the graft part₁ forms the innermost layer of the graft part, a layer of the graft part₂ is formed on the outer side of the graft part₁, and a layer of the graft part₃ is formed on the outer side of the layer of the graft part₂ as the outermost layer. Thus, it can also be said that the multistage-polymerization graft part in which the graft parts form a layer structure is a multilayered graft part. In other words, in one or more embodiments of the present invention, the graft part may include (i) a complex of plurality of types of graft parts, (ii) a multistage-polymerization graft part, and/or (iii) a multilayered graft part.

In a case where a polymer (e.g., elastic body described later) and the graft part are formed in this order by polymerization in production of the fine polymer particles (A), at least part of the graft part can cover at least part of the polymer in the resulting fine polymer particles (A). The wording “a polymer and a graft part are formed in this order by polymerization” can be reworded as follows: a polymer and the graft part are subjected to multistage polymerization. It can also be said that the fine polymer particles (A) obtained by multistage polymerization of the polymer and a graft part are a multistage polymer.

In a case where the fine polymer particles (A) are constituted by a multistage polymer, the graft part can cover at least part or the whole of the polymer (e.g., elastic body described later). In a case where the fine polymer particles (A) are constituted by a multistage polymer, part of the graft part may be located inside the polymer. At least part of the graft part preferably covers at least part of the elastic body. In other words, at least part of the graft part is preferably present on the outermost side of the fine polymer particles (A).

In a case where the fine polymer particles (A) are constituted by a multistage polymer, a polymer (e.g., the elastic body described later) and the graft part may form a layer structure. For example, aspects of one or more embodiments of the present invention also include an aspect in which the elastic body forms the innermost layer (also referred to as a core layer) and a layer of the graft part is formed on the outer side of the elastic body as the outermost layer (also referred to as a shell layer). It can also be said that a structure in which the elastic body is present as a core layer and the graft part is present as a shell layer is a core-shell structure. It can also be said that the fine polymer particles (A) that contain the elastic body and the graft part which form a layer structure (core-shell structure) are constituted by a multilayered polymer or a core-shell polymer. In other words, in one or more embodiments of the present invention, the fine polymer particles (A) may be constituted by a multistage polymer and/or a multilayered polymer or a core-shell polymer. Note, however, that the fine polymer particles (A) are not limited to the above feature, provided that the fine polymer particles (A) have the graft part.

(Elastic Body)

The fine polymer particles (A) preferably further have the elastic body. The foregoing graft part is preferably a polymer grafted to an elastic body. That is, the fine polymer particles (A) are more preferably constituted by a rubber-containing graft copolymer which has the elastic body and the graft part grafted to the elastic body. The following description will discuss one or more embodiments of the present invention while taking as an example a case where the fine polymer particles (A) are constituted by a rubber-containing graft copolymer.

The elastic body preferably contains at least one selected from the group consisting of diene-based rubbers, (meth)acrylate-based rubbers, and organosiloxane-based rubbers. The elastic body may contain natural rubber other than the above described rubber. The elastic body can also be referred to as elastic part(s) or rubber particle(s).

A case where the elastic body includes a diene-based rubber (case A) will be described. In the case A, the resin composition to be obtained can provide a cured product which has excellent toughness and impact resistance. It can be said that a cured product that has excellent toughness and/or excellent impact resistance is a cured product that has excellent durability.

The diene-based rubber is an elastic body containing, as a structural unit, a structural unit derived from a diene-based monomer. The diene-based monomer can also be referred to as a conjugated diene-based monomer. In the case A, the diene-based rubber may contain (i) the structural unit derived from the diene-based monomer in an amount of 50% by weight to 100% by weight and (ii) a structural unit derived from a vinyl-based monomer, which is different from the diene-based monomer and which is copolymerizable with the diene-based monomer, in an amount of 0% by weight to 50% by weight, with respect to 100% by weight of structural units. In the case A, the diene-based rubber may contain, as a structural unit, a structural unit derived from a (meth)acrylate-based monomer in an amount smaller than the amount of the structural unit derived from the diene-based monomer.

Examples of the diene-based monomer encompass 1,3-butadiene, isoprene (2-methyl-1,3-butadiene), and 2-chloro-1,3-butadiene. These diene-based monomers may be used alone or in combination of two or more.

Examples of the vinyl-based monomer which is different from the diene-based monomer and which is copolymerizable with the diene-based monomer (hereinafter also referred to as vinyl-based monomer A) encompass: vinyl arenes such as styrene, α-methylstyrene, monochlorostyrene, and dichlorostyrene; vinyl carboxylic acids such as acrylic acid and methacrylic acid; vinyl cyanides such as acrylonitrile and methacrylonitrile; vinyl halides such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinylbenzene. These vinyl-based monomers A may be used alone or in combination of two or more. Out of these vinyl-based monomers A, styrene is particularly preferable. Note that, in the diene-based rubber in the case A, the structural unit derived from the vinyl-based monomer A is an optional component. Note that, in the case A, the diene-based rubber may be constituted by only the structural unit derived from the diene-based monomer.

In the case A, the diene-based rubber is preferably (i) butadiene rubber which is constituted by a structural unit derived from 1,3-butadiene (also referred to as polybutadiene rubber) or (ii) butadiene-styrene rubber which is a copolymer of 1,3-butadiene and styrene (also referred to as polystyrene-butadiene). The diene-based rubber is more preferably butadiene rubber. According to the above feature, since the fine polymer particles (A) contain the diene-based rubber, a desired effect can be more brought about. The butadiene-styrene rubber is more preferable in that the butadiene-styrene rubber makes it possible to, by adjustment of a refractive index, increase the transparency of a cured product to be obtained.

A case where the elastic body includes a (meth)acrylate-based rubber (case B) will be described. The case B allows wide-ranging polymer design for the elastic body by combinations of many types of monomers.

The (meth)acrylate-based rubber is an elastic body containing, as a structural unit, a structural unit derived from a (meth)acrylate-based monomer. In the case B, the (meth)acrylate-based rubber may contain (i) the structural unit derived from the (meth)acrylate-based monomer in an amount of 50% by weight to 100% by weight and (ii) a structural unit derived from a vinyl-based monomer, which is different from the (meth)acrylate-based monomer and which is copolymerizable with the (meth)acrylate-based monomer, in an amount of 0% by weight to 50% by weight, with respect to 100% by weight of structural units. In the case B, the (meth)acrylate-based rubber may contain, as a structural unit, a structural unit derived from a diene-based monomer in an amount smaller than the amount of the structural unit derived from the (meth)acrylate-based monomer.

Examples of the (meth)acrylate-based monomer encompass: alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; aromatic ring-containing (meth)acrylates such as phenoxyethyl (meth)acrylate and benzyl (meth)acrylate; hydroxyalkyl (meth)acrylates such as 2-hydroxyethyl (meth)acrylate and 4-hydroxybutyl (meth)acrylate; glycidyl (meth)acrylates such as glycidyl (meth)acrylate and glycidyl alkyl (meth)acrylate; alkoxy alkyl (meth)acrylates; allyl alkyl (meth)acrylates such as allyl (meth)acrylate and allyl alkyl (meth)acrylates; and polyfunctional (meth)acrylates such as monoethylene glycol di(meth)acrylate, triethylene glycol di(meth)acrylate, and tetraethylene glycol di(meth)acrylate. These (meth)acrylate-based monomers may be used alone or in combination of two or more. Out of these (meth)acrylate-based monomers, ethyl (meth)acrylate, butyl (meth)acrylate, and 2-ethylhexyl (meth)acrylate are preferred, and butyl (meth)acrylate is more preferred.

In the case B, the (meth)acrylate-based rubber is preferably at least one selected from the group consisting of ethyl (meth)acrylate rubbers, butyl (meth)acrylate rubbers, and 2-ethylhexyl (meth)acrylate rubbers, and is more preferably a butyl (meth)acrylate rubber. An ethyl (meth)acrylate rubber is a rubber composed of structural units derived from ethyl (meth)acrylate(s), a butyl (meth)acrylate rubber is a rubber composed of structural units derived from butyl (meth)acrylate(s), and a 2-ethylhexyl (meth)acrylate rubber is a rubber composed of structural units derived from 2-ethylhexyl (meth)acrylate(s). With this feature, the glass transition temperature (Tg) of the elastic body is low, and therefore fine polymer particles (A) and a resin composition having low Tg are obtained. As a result, (i) a resultant resin composition can provide a cured product having excellent toughness, and (ii) it is possible to cause the resin composition to have a lower viscosity.

Examples of the vinyl-based monomer which is different from the (meth)acrylate-based monomer and which is copolymerizable with the (meth)acrylate-based monomer (hereinafter also referred to as vinyl-based monomer B) encompass the monomers listed as the examples of the vinyl-based monomer A. Such vinyl-based monomers B may be used alone or in combination of two or more. Out of such vinyl-based monomers B, styrene is particularly preferable. Note that, in the (meth)acrylate-based rubber in the case B, the structural unit derived from the vinyl-based monomer B is an optional component. Note that, in the case B, the (meth)acrylate-based rubber may be constituted by only the structural unit derived from the (meth)acrylate-based monomer.

A case where the elastic body includes an organosiloxane-based rubber (case C) will be described. In the case C, the resin composition to be obtained can provide a cured product which has sufficient heat resistance and which has excellent impact resistance at low temperatures.

Examples of the organosiloxane-based rubber encompass (i) organosiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy, and (ii) organosiloxane-based polymers composed of alkyl or aryl monosubstituted silyloxy units, such as organohydrogensilyloxy in which some of sidechain alkyls have been substituted with hydrogen atoms. These organosiloxane-based polymers may be used alone or in combination of two or more.

In the present specification, a polymer composed of dimethylsilyloxy unit is referred to as a dimethylsilyloxy rubber, a polymer composed of methylphenylsilyloxy unit is referred to as a methylphenylsilyloxy rubber, and a polymer composed of dimethylsilyloxy unit and diphenylsilyloxy unit is referred to as a dimethylsilyloxy-diphenylsilyloxy rubber. In the case C, the organosiloxane-based rubber is preferably (i) at least one selected from the group consisting of dimethylsilyloxy rubbers, methylphenylsilyloxy rubbers and dimethylsilyloxy-diphenylsilyloxy rubbers, because a resin composition which contains the resulting powdery and/or granular material can provide a cured product or molded product which has excellent heat resistance, and is more preferably (ii) a dimethylsilyloxy rubber because it can be easily obtained and is economical.

In the case C, it is preferable that the fine polymer particles (A) contain an organosiloxane-based rubber in an amount of not less than 80% by weight, more preferably not less than 90% by weight, with respect to 100% by weight of the elastic body contained in the fine polymer particles (A). According to the above feature, the resin composition to be obtained can provide a cured product which has excellent heat resistance.

The elastic body may further include an elastic body other than the diene-based rubber, the (meth)acrylate-based rubber, and the organosiloxane-based rubber. Examples of the elastic body other than the diene-based rubber, the (meth)acrylate-based rubber, and the organosiloxane-based rubber encompass natural rubber.

In one or more embodiments of the present invention, the elastic body is preferably at least one selected from the group consisting of butadiene rubbers, butadiene-styrene rubbers, butadiene-(meth)acrylate rubbers, ethyl (meth)acrylate rubbers, butyl (meth)acrylate rubbers, 2-ethylhexyl (meth)acrylate rubbers, dimethylsilyloxy rubbers, methylphenylsilyloxy rubbers, and dimethylsilyloxy-diphenylsilyloxy rubbers, and is more preferably at least one selected from the group consisting of butadiene rubbers, butadiene-styrene rubbers, butyl (meth)acrylate rubbers, and dimethylsilyloxy rubbers.

(Crosslinked Structure of Elastic Body)

The elastic body preferably has a crosslinked structure introduced therein, from the viewpoint of maintenance of stable dispersion of the fine polymer particles (A) in a thermosetting resin. A generally used method may be used to introduce a crosslinked structure into the elastic body. Examples of the generally used method encompass the following. That is, in production of the elastic body, a crosslinking monomer(s), such as a polyfunctional monomer and/or a mercapto group-containing compound, is/are mixed with a monomer which can constitute the elastic body, and then polymerization is carried out. In the present specification, producing a polymer such as the elastic body is also referred to as forming a polymer by polymerization.

A method for introducing a crosslinked structure into an organosiloxane-based rubber includes the following methods: (A) a method that involves using a polyfunctional alkoxysilane compound in combination with another material during formation of the organosiloxane-based rubber by polymerization: (B) a method that involves introducing, into the organosiloxane-based rubber, a reactive group (e.g., (i) mercapto group, (ii) vinyl group having reactivity, and the like), and then adding (i) an organic peroxide, (ii) a polymerizable vinyl monomer, or the like to the obtained reaction product to cause a radical reaction; and (C) a method that involves, during formation of the organosiloxane-based rubber by polymerization, mixing a crosslinking monomer(s), such as a polyfunctional monomer and/or a mercapto group-containing compound, together with another material and then carrying out polymerization.

Examples of the polyfunctional monomer encompass the polyfunctional monomers listed as the examples in the section (Graft part).

Examples of the mercapto group-containing compound encompass alkyl group-substituted mercaptan, allyl group-substituted mercaptan, aryl group-substituted mercaptan, hydroxy group-substituted mercaptan, alkoxy group-substituted mercaptan, cyano group-substituted mercaptan, amino group-substituted mercaptan, silyl group-substituted mercaptan, acid radical-substituted mercaptan, halo group-substituted mercaptan, and acyl group-substituted mercaptan. The alkyl group-substituted mercaptan is preferably alkyl group-substituted mercaptan having 1 to 20 carbon atoms, and is more preferably alkyl group-substituted mercaptan having 1 to 10 carbon atoms. The aryl group-substituted mercaptan is preferably phenyl group-substituted mercaptan. The alkoxy group-substituted mercaptan is preferably alkoxy group-substituted mercaptan having 1 to 20 carbon atoms, and is more preferably alkoxy group-substituted mercaptan having 1 to 10 carbon atoms. The acid radical-substituted mercaptan is preferably alkyl group-substituted mercaptan having a carboxyl group and 1 to 10 carbon atoms or aryl group-substituted mercaptan having a carboxyl group and 1 to 12 carbon atoms.

(Glass Transition Temperature of Elastic Body)

The elastic body has a glass transition temperature of preferably not higher than 80° C., more preferably not higher than 70° C., more preferably not higher than 60° C., more preferably not higher than 50° C., more preferably not higher than 40° C., more preferably not higher than 30° C., more preferably not higher than 20° C., more preferably not higher than 10° C., more preferably not higher than 0° C., more preferably not higher than −20° C., more preferably not higher than −40° C., more preferably not higher than −45° C., more preferably not higher than −50° C., more preferably not higher than −55° C., more preferably not higher than −60° C., more preferably not higher than −65° C., more preferably not higher than −70° C., more preferably not higher than −75° C., more preferably not higher than −80° C., more preferably not higher than −85° C., more preferably not higher than −90° C., more preferably not higher than −95° C., more preferably not higher than −100° C., more preferably not higher than −105° C., more preferably not higher than −110° C., more preferably not higher than −115° C., even more preferably not higher than −120° C., particularly preferably not higher than −125° C. In the present specification, the “glass transition temperature” may be referred to as “Tg”. With this feature, it is possible to obtain fine polymer particles (A) having low Tg and a resin composition having low Tg. As a result, a resin composition can provide a cured product each of which has excellent toughness. According to the above feature, the resultant resin composition can have a lower viscosity. The Tg of the elastic body can be obtained by carrying out viscoelasticity measurement with use of a planar plate made of the fine polymer particles (A). Specifically, the Tg can be measured as follows: (1) a graph of tan δ is obtained by carrying out dynamic viscoelasticity measurement with respect to a planar plate made of the fine polymer particles (A), with use of a dynamic viscoelasticity measurement device (for example, DVA-200, manufactured by IT Keisoku Seigyo Kabushikigaisha) under a tension condition; and (2) in the graph of tan δ thus obtained, the peak temperature of tan δ is regarded as the glass transition temperature. Note, here, that in a case where a plurality of peaks is found in the graph of tan δ, the lowest peak temperature is regarded as the glass transition temperature of the elastic body.

In view of prevention of a decrease in elastic modulus (i.e., a decrease in rigidity) of the resulting cured product, i.e., in view of obtainment of the cured product which has a sufficient elastic modulus (rigidity), the Tg of the elastic body is preferably higher than 0° C., more preferably not lower than 20° C., even more preferably not lower than 50° C., particularly preferably not lower than 80° C., most preferably not lower than 120° C.

The Tg of the elastic body can be determined by, for example, the composition of the structural unit contained in the elastic body. In other words, it is possible to adjust the Tg of the resulting elastic body by changing the composition of the monomer used to produce (form by polymerization) the elastic body.

Note, here, that monomers each of which, when polymerized to form a homopolymer (i.e., a polymer obtained by polymerizing only one type of monomer), provides a homopolymer having a Tg of higher than 0° C. will be referred to as a monomer group “a”. Note also that monomers each of which, when polymerized to form a homopolymer (i.e., a polymer obtained by polymerizing only one type of monomer), provides a homopolymer having a Tg of lower than 0° C. will be referred to as a monomer group “b”. Note also that an elastic body containing (i) one or more structural units derived from at least one type of monomer selected from the monomer group “a” in an amount of 50% by weight to 100% by weight (more preferably 65% by weight to 99% by weight) and (ii) one or more structural units derived from at least one type of monomer selected from the monomer group “b” in an amount of 0% by weight to 50% by weight (more preferably 1% by weight to 35% by weight) will be referred to as an elastic body G. The elastic body G has a Tg higher than 0° C. In a case where the elastic body includes the elastic body G, the resin composition to be obtained can provide a cured product which has sufficient rigidity.

Also in a case where the Tg of the elastic body is higher than 0° C., it is preferable that the crosslinked structure be introduced in the elastic body. Examples of a method for introducing the crosslinked structure into the elastic body encompass the above-described methods.

Examples of the monomers which can be included in the monomer group “a” encompass, but are not limited to, unsubstituted vinyl aromatic compounds such as styrene and 2-vinyl naphthalene; vinyl-substituted aromatic compounds such as α-methylstyrene; ring-alkylated vinyl aromatic compounds such as 3-methylstyrene, 4-methylstyrene, 2,4-dimethylstyrene, 2,5-dimethylstyrene, 3,5-dimethylstyrene, and 2,4,6-trimethylstyrene; ring-alkoxylated vinyl aromatic compounds such as 4-methoxystyrene and 4-ethoxystyrene; ring-halogenated vinyl aromatic compounds such as 2-chlorostyrene and 3-chlorostyrene; ring-ester-substituted vinyl aromatic compounds such as 4-acetoxy styrene; ring-hydroxylated vinyl aromatic compounds such as 4-hydroxystyrene; vinyl esters such as vinyl benzoate and vinyl cyclohexanoate; vinyl halides such as vinyl chloride; aromatic monomers such as acenaphthalene and indene; alkyl methacrylates such as methyl methacrylate, ethyl methacrylate, and isopropyl methacrylate; aromatic methacrylates such as phenyl methacrylate; methacrylates such as isobornyl methacrylate and trimethylsilyl methacrylate; methacrylic acid derivative-containing methacryl monomers such as methacrylonitrile; certain types of acrylic acid esters such as isobornyl acrylate and tert-butyl acrylate; and acrylic acid derivative-containing acrylic monomers such as acrylonitrile. Examples of the monomers which can be included in the monomer group “a” further encompass monomers each of which, when polymerized, can provide a homopolymer having a Tg of not lower than 120° C., such as acrylamide, isopropyl acrylamide, N-vinylpyrrolidone, isobornyl methacrylate, dicyclopentanyl methacrylate, 2-methyl-2-adamanthyl methacrylate, 1-adamanthyl acrylate, and 1-adamanthyl methacrylate. These monomers “a” may be used alone or in combination of two or more.

Examples of monomers “b” encompass ethyl acrylate, butyl acrylate, 2-ethylhexyl acrylate, octyl (meth)acrylate, dodecyl (meth)acrylate, 2-hydroxyethyl acrylate, and 4-hydroxybutyl acrylate. These monomers “b” may be used alone or in combination of two or more. Out of these monomers “b”, ethyl acrylate, butyl acrylate, and 2-ethylhexyl acrylate are particularly preferable.

(Volume-Average Particle Size of Elastic Body)

The elastic body has a volume-average particle size of preferably 0.03 μm to 50.00 μm, more preferably 0.05 μm to 10.00 μm, more preferably 0.08 μm to 2.00 μm, further preferably 0.10 μm to 1.00 μm, even more preferably 0.10 μm to 0.80 μm, particularly preferably 0.10 μm to 0.50 μm. In a case where the volume-average particle size of the elastic body is not less than 0.03 μm, the elastic body which has a desired volume-average particle size can be stably obtained. In a case where the volume-average particle size of the elastic body is not more than 50.00 μm, the resulting cured product or the resulting molded product has favorable heat resistance and impact resistance. The volume-average particle size of the elastic body can be measured with use of, for example, a dynamic light scattering type particle size distribution measurement apparatus using, as a test specimen, an aqueous suspension containing the elastic body. A method for measuring the volume-average particle size of the elastic body will be described later in detail in Examples.

(Proportion of Elastic Body)

A proportion of the elastic body contained in the fine polymer particles (A) is preferably 40% by weight to 97% by weight, more preferably 60% by weight to 95% by weight, even more preferably 70% by weight to 93% by weight, where 100% by weight represents the entirety of the fine polymer particles (A). In a case where the proportion of the elastic body is not less than 40% by weight, the resulting resin composition can provide the cured product which has excellent toughness and impact resistance. In a case where the proportion of the elastic body is not more than 97% by weight, the fine polymer particles (A) do not easily agglutinate and, therefore, the resin composition does not have a high viscosity, so that the resulting resin composition can be excellent in handling.

(Gel Content of Elastic Body)

The elastic body is preferably one that can swell in an appropriate solvent but is substantially insoluble in the appropriate solvent. The elastic body is preferably insoluble in a thermosetting resin used.

The elastic body has a gel content of preferably not less than 60% by weight, more preferably not less than 80% by weight, even more preferably not less than 90% by weight, particularly preferably not less than 95% by weight. In a case where the gel content of the elastic body falls within the above range, the resin composition to be obtained can provide a cured product which has excellent toughness.

In the present specification, a method for calculating the gel content is as follows. First, an aqueous suspension containing the fine polymer particles (A) is obtained. Next, a powdery and/or granular material of the fine polymer particles (A) is obtained from the aqueous suspension. A method for obtaining the powdery and/or granular material of the fine polymer particles (A) from the aqueous suspension is not limited to any particular one, and examples thereof encompass a method for obtaining the powdery and/or granular material of the fine polymer particles (A) by (i) causing the fine polymer particles (A) in the aqueous suspension to agglutinate, (ii) dehydrating the agglutinate thus obtained, and (iii) further drying the agglutinate. Next, 2.0 g of the powdery and/or granular material of the fine polymer particles (A) is dissolved in 50 mL of methyl ethyl ketone (MEK). The MEK solution of the powder thus obtained is separated into a part soluble in MEK (MEK-soluble part) and a part insoluble in MEK (MEK-insoluble part). Specifically, the obtained MEK solution of the powder is subjected to centrifugal separation with use of a centrifugal separator (CP60E, manufactured by Hitachi Koki Co., Ltd.) at a rotation speed of 30000 rpm for 1 hour, and thereby separated into the MEK-soluble part and the MEK-insoluble part. Note, here, that three sets of centrifugal separations are carried out in total. The weight of the obtained MEK-soluble part and the weight of the MEK-insoluble part are measured, and then the gel content is calculated with use of the following formula.

Gel content (%)=(weight of methyl ethyl ketone insoluble part)/{(weight of methyl ethyl ketone insoluble part)+(weight of methyl ethyl ketone soluble part)}×100

(Variations of Elastic Body)

In one or more embodiments of the present invention, the “elastic body” of the fine polymer particles (A) may be composed of one type of elastic body which has an identical structural unit composition. In such a case, the “elastic body” of the fine polymer particles (A) may be one selected from the group consisting of diene-based rubbers, (meth)acrylate-based rubbers, and organosiloxane-based rubbers.

In one or more embodiments of the present invention, the “elastic body” of the fine polymer particles (A) may be composed of a plurality of types of elastic bodies which differ in structural unit composition from each other. In such a case, the “elastic body” of the fine polymer particles (A) may be two or more types selected from the group consisting of diene-based rubbers, (meth)acrylate-based rubbers, and organosiloxane-based rubbers. In such a case, the “elastic body” of the fine polymer particles (A) may be one selected from the group consisting of diene-based rubbers, (meth)acrylate-based rubbers, and organosiloxane-based rubbers. In other words, the “elastic body” of the fine polymer particles (A) may be a plurality of types, which differ in structural unit composition from each other, of the following rubbers: diene-based rubbers, (meth)acrylate-based rubbers, or organosiloxane-based rubbers.

In one or more embodiments of the present invention, a case where the “elastic body” of the fine polymer particles (A) is composed of a plurality of types of elastic bodies which differ in structural unit composition from each other will be described. In this case, the plurality of types of elastic bodies will be referred to as an elastic body₁, an elastic body₂, . . . and an elastic bodyₙ, respectively. Note, here, that “n” is an integer of 2 or more. The “elastic body” of the fine polymer particles (A) may include a complex of the elastic body₁, the elastic body₂, . . . , and the elastic body, which have been individually formed by polymerization. The “elastic body” of the fine polymer particles (A) may include one elastic body obtained by forming the elastic body₁, the elastic body₂, . . . , and the elastic body, in order by polymerization. Forming a plurality of elastic bodies (polymers) by polymerization in order in this manner is also referred to as multistage polymerization. One elastic body obtained by multistage polymerization of a plurality of types of elastic bodies is also referred to as a multistage-polymerization elastic body. A method for producing a multistage-polymerization elastic body will be later described in detail.

A multistage-polymerization elastic body constituted by the elastic body₁, the elastic body₂, . . . and the elastic body, will be described. In the multistage-polymerization elastic body, the elastic body, can cover at least part of an elastic bodyₙ₋₁ or the whole of the elastic bodyₙ₋₁. In the multistage-polymerization elastic body, part of the elastic bodyₙ may be located inside the elastic bodyₙ₋₁.

In the multistage-polymerization elastic body, the plurality of elastic bodies may form a layer structure. For example, in a case where the multistage-polymerization elastic body is constituted by the elastic body₁, the elastic body₂, and an elastic body₃, aspects of one or more embodiments of the present invention also include an aspect in which the elastic body₁ forms the innermost layer, a layer of the elastic body₂ is formed on the outer side of the elastic body₁, and a layer of the elastic body₃ is formed on the outer side of the layer of the elastic body₂ as the outermost layer of the elastic body. Thus, it can also be said that the multistage-polymerization elastic body in which the plurality of elastic bodies form a layer structure is a multilayered elastic body. In other words, in one or more embodiments of the present invention, the “elastic body” of the fine polymer particles (A) may include (i) a complex of a plurality of types of elastic bodies, (ii) a multistage-polymerization elastic body, and/or (iii) a multilayered elastic body.

(Surface-Crosslinked Polymer)

The rubber-containing graft copolymer preferably further has a surface-crosslinked polymer in addition to the elastic body and the graft part grafted to the elastic body. In other words, the fine polymer particles (A) preferably further have a surface-crosslinked polymer in addition to the elastic body and the graft part grafted to the elastic body. One or more embodiments of the present invention will be described with reference to an example case in which the fine polymer particles (A) (e.g., rubber-containing graft copolymer) further has a surface-crosslinked polymer. In this case, (i) it is possible to make an improvement of an anti-blocking property in the production of the fine polymer particles (A) and (ii) the dispersibility of the fine polymer particles (A) in the thermosetting resin is made more favorable. Reasons for these are not limited to any particular ones, but can be inferred as follows. By the surface-crosslinked polymer covering at least part of the elastic body, the exposed area of the elastic body of the fine polymer particles (A) is reduced. Consequently, the elastic body is less likely to adhere to another elastic body, and therefore the dispersibility of the fine polymer particles (A) is improved.

In a case where the fine polymer particles (A) have the surface-crosslinked polymer, the following effects can be further brought about: (i) an effect of reducing the viscosity of the resin composition described later; (ii) an effect of increasing the crosslinking density of the elastic body; and (iii) an effect of increasing the graft efficiency of the graft part. Note that the crosslinking density of the elastic body is intended to mean a degree of the number of crosslinked structures in the entirety of the elastic body.

The surface-crosslinked polymer is constituted by a polymer containing, as structural units, (i) a structural unit(s) derived from a polyfunctional monomer(s) in an amount of 30% by weight to 100% by weight and (ii) a structural unit(s) derived from vinyl-based monomer(s), other than the unit(s) derived from polyfunctional monomer(s), in an amount of 0% by weight to 70% by weight, which total 100% by weight.

Examples of the polyfunctional monomer which can be used to form the surface-crosslinked polymer by polymerization encompass polyfunctional monomers identical to the foregoing polyfunctional monomers. Out of such polyfunctional monomers, examples of a polyfunctional monomer which can be preferably used to form the surface-crosslinked polymer by polymerization encompass allyl methacrylate, ethylene glycol di(meth)acrylate, butylene glycol di(meth)acrylate (such as 1,3-butylene glycol dimethacrylate), butanediol di(meth)acrylate, hexanediol di(meth)acrylate, cyclohexane dimethanol di(meth)acrylate, and polyethylene glycol di(meth)acrylates. Such polyfunctional monomers may be used alone or in combination of two or more.

The fine polymer particles (A) may contain the surface-crosslinked polymer which is formed by polymerization independently of formation of the rubber-containing graft copolymer by polymerization, or may contain the surface-crosslinked polymer which is formed together with the rubber-containing graft copolymer by polymerization. The fine polymer particles (A) may be a multistage polymer obtained by forming the elastic body, the surface-crosslinked polymer, and the graft part in this order by multistage polymerization. In any of these aspects, the surface-crosslinked polymer can cover at least part of the elastic body.

The surface-crosslinked polymer can also be regarded as part of the elastic body. In other words, the surface-crosslinked polymer can also be regarded as part of the rubber-containing graft copolymer, and can be said to be a surface cross-linked polymerized part. In a case where the fine polymer particles (A) contain the surface-crosslinked polymer, the graft part may (i) be grafted to the elastic body other than the surface-crosslinked polymer, (ii) be grafted to the surface-crosslinked polymer, or (iii) be grafted to both the elastic body other than the surface-crosslinked polymer and the surface-crosslinked polymer. In a case where the fine polymer particles (A) contain the surface-crosslinked polymer, the above-described volume-average particle size of the elastic body is intended to mean the volume-average particle size of the elastic body including the surface-crosslinked polymer.

A case will be described where the fine polymer particles (A) are a multistage polymer obtained by forming the elastic body, the surface-crosslinked polymer, and the graft part in this order by multistage polymerization (case D). In the case D, the surface-crosslinked polymer can cover part of the elastic body or the whole of the elastic body. In the case D, part of the surface-crosslinked polymer may be located inside the elastic body. In the case D, the graft part can cover part of the surface-crosslinked polymer or the whole of the surface-crosslinked polymer. In the case D, part of the graft part may be located inside the surface-crosslinked polymer. In the case D, the elastic body, the surface-crosslinked polymer, and the graft part may form a layer structure. For example, aspects of one or more embodiments of the present invention also include an aspect in which the elastic body is present as the innermost layer (core layer), a layer of the surface-crosslinked polymer is present on the outer side of the elastic body as an intermediate layer, and a layer of the graft part is present on the outer side of the surface-crosslinked polymer as the outermost layer (shell layer).

(Volume-Average Particle Size (Mv) of Fine Polymer Particles (A))

The volume-average particle size (Mv) of the fine polymer particles (A) is preferably 0.03 μm to 50.00 μm, more preferably 0.05 μm to 10.00 μm, more preferably 0.08 μm to 2.00 μm, further preferably 0.10 μm to 1.00 μm, even more preferably 0.10 μm to 0.80 μm, particularly preferably 0.10 μm to 0.50 μm, because it is possible to obtain a resin composition which has a desired viscosity and which is highly stable. In a case where the volume-average particle size (Mv) of the fine polymer particles (A) falls within the above range, there is also an advantage that the dispersibility of the fine polymer particles (A) in the resin (D) (such as a thermosetting resin) is favorable. Note that, in the present specification, the “volume-average particle size (Mv) of the fine polymer particles (A)” is intended to mean the volume-average particle size of the primary particles of the fine polymer particles (A) unless otherwise specifically mentioned. The volume-average particle size of the fine polymer particles (A) can be measured with use of, for example, a dynamic light scattering type particle size distribution measurement apparatus using, as a sample, an aqueous latex containing the fine polymer particles (A).

(1-2-3. Fine Polymer Particles (A) Production Method)

An example of the fine polymer particle (A) production method will discussed using, as an example, a case where the fine polymer particles (A) contain a rubber-containing graft copolymer that includes an elastic body and a graft part grafted to the elastic body. The fine polymer particles (A) can be produced, for example, as follows: After an elastic body is formed by polymerization, the polymer which constitutes the graft part is graft polymerized to the elastic body in the presence of the elastic body.

The fine polymer particles (A) can be produced by a known method, for example, a method such as an emulsion polymerization method, a suspension polymerization method, or a microsuspension polymerization method. Specifically, the formation of the elastic body by polymerization in the fine polymer particles (A), the formation of the graft part by polymerization in the fine polymer particles (A) (graft polymerization), and the formation of the surface-crosslinked polymer by polymerization in the fine polymer particles (A) can be each achieved by a known method, for example, a method such as an emulsion polymerization method, a suspension polymerization method, or a microsuspension polymerization method. Out of these methods, the emulsion polymerization method is particularly preferable as the method for producing the fine polymer particles (A). The emulsion polymerization has an advantage of (i) making a compositional design of the fine polymer particles (A) easy, (ii) making industrial production of the fine polymer particles (A) easy, and (iii) making it easy to obtain a latex that is suitable for use in the first production method. A method for producing the elastic body which can be contained in the fine polymer particles (A), a method for producing the graft part which can be contained in the fine polymer particles (A), and a method for producing the surface-crosslinked polymer which can be optionally contained in the fine polymer particles (A) will be described below.

(Method for Producing Elastic Body)

A case will be considered where the elastic body includes at least one type selected from the group consisting of diene-based rubbers and (meth)acrylate-based rubbers. In this case, the elastic body can be produced by, for example, a method such as emulsion polymerization, suspension polymerization, or microsuspension polymerization. As the method for producing the elastic body, a method disclosed in, for example, WO 2005/028546 can be used.

A case where the elastic body includes an organosiloxane-based rubber will be described. In this case, the elastic body can be produced by, for example, a method such as emulsion polymerization, suspension polymerization, or microsuspension polymerization. As the method for producing the elastic body, a method disclosed in, for example, WO 2006/070664 can be used.

A case where the “elastic body” of the fine polymer particles (A) is constituted by a plurality of types of elastic bodies (for example, an elastic body₁, an elastic body₂, . . . , an elastic bodyₙ) will be described. In this case, a complex which is constituted by the plurality of types of elastic bodies may be produced in the following manner: the elastic body₁, the elastic body₂, . . . and the elastic bodyₙ are each polymerized individually by any of the above-described methods, and then these elastic bodies are mixed and complexed. Alternatively, the elastic body₁, the elastic body₂, . . . and the elastic body, may be formed in order by multistage polymerization to produce one elastic body which is constituted by the plurality of types of elastic bodies.

The multistage polymerization of the elastic bodies will be described in detail. For example, the multistage-polymerization elastic body can be obtained by carrying out in order the following steps (1) through (4): (1) The elastic body₁ is formed by polymerization; (2) next, the elastic body₂ is formed by polymerization in the presence of the elastic body₁ to obtain a two-stage elastic body₁₊₂; (3) subsequently, an elastic body₃ is formed by polymerization in the presence of the elastic body₁₊₂ to obtain a three-stage elastic body₁₊₂₊₃; and (4) after a similar process(es) is/are carried out, the elastic body, is formed by polymerization in the presence of an elastic body_{1+2+ . . . +(n-1)} to obtain a multistage-polymerization elastic body_{1+2+ . . . +n}.

(Method for Producing Graft Part)

The graft part can be formed, for example, by polymerizing, by known radical polymerization, monomers used to form the graft part in the presence of a polymer (such as an elastic body). In a case where (i) the elastic body is obtained as an aqueous suspension or (ii) a fine polymer particle precursor containing the elastic body and the surface-crosslinked polymer is obtained as an aqueous suspension, the graft part is preferably formed by emulsion polymerization. The graft part can be produced by a method disclosed in, for example, WO 2005/028546.

The method for producing the graft part in a case where the graft part is constituted by a plurality of types of graft parts (for example, a graft part₁, a graft part₂, . . . , a graft partₙ) will be described. In this case, the graft part (complex) which is constituted by the plurality of types of graft parts may be produced in the following manner: the graft part₁, the graft part₂, . . . and the graft partₙ are each polymerized individually by any of the above-described methods, and then these graft parts are mixed and complexed. Alternatively, the graft part₁, the graft part₂, . . . the graft partₙ may be formed in order by multistage polymerization to produce one graft part which is constituted by the plurality of types of graft parts.

The multistage polymerization of the graft parts will be described in detail. For example, the multistage-polymerization graft part can be obtained by carrying out in order the following steps (1) through (4): (1) The graft part₁ is formed by polymerization; (2) next, the graft part₂ is formed by polymerization in the presence of the graft part₁ to obtain a two-stage graft part₁₊₂; (3) subsequently, a graft part₃ is formed by polymerization in the presence of the graft part₁₊₂ to obtain a three-stage graft part₁₊₂₊₃; and (4) after a similar process(es) is/are carried out, the graft partₙ is formed by polymerization in the presence of a graft part_{1+2+ . . . +(n-1)} to obtain a multistage-polymerization graft part_{1+2+ . . . +n}.

In a case where the graft part is constituted by the plurality of types of graft parts, the fine polymer particles (A) may be produced as follows: the graft part which is constituted by the plurality of types of graft parts is formed by polymerization, and then these graft parts are graft polymerized to the elastic body. The fine polymer particles (A) may be produced as follows: in the presence of the elastic body, a plurality of types of polymers which constitute the graft part are formed in order by multistage graft polymerization with respect to the elastic body.

(Method for Producing Surface-Crosslinked Polymer)

The surface-crosslinked polymer can be formed by polymerizing, by known radical polymerization, monomers used to form the surface-crosslinked polymer in the presence of a polymer (such as an elastic body). In a case where the elastic body is obtained as an aqueous suspension, the surface-crosslinked polymer is preferably formed by emulsion polymerization.

In a case where emulsion polymerization is employed as the fine polymer particle (A) production method, a known emulsifying agent (dispersion agent) as an emulsifying agent (dispersion agent) can be used in the production of the fine polymer particles (A). The emulsifying agent preferably has a polyoxyethylene group. The emulsifying agent having a polyoxyethylene group will be described later in detail in the section (2-4. Emulsifying agent). In the production of the fine polymer particles (A) by the emulsion polymerization, the following advantages (i) and (ii) are brought about by using an emulsifying agent having a polyoxyethylene group as an emulsifying agent: (i) a latex suitable for use in the first production method can be easily obtained; and (ii) is possible to reduce the environmental impact.

In a case where emulsion polymerization is employed as the method for producing the fine polymer particles (A), a pyrolytic initiator can be used in the production of the fine polymer particles (A). It is possible to use, as the pyrolytic initiator, a known initiator such as (i) 2,2′-azobisisobutyronitrile, and (ii) peroxides such as organic peroxides and inorganic peroxides, for example. Examples of the organic peroxide encompass t-butylperoxy isopropyl carbonate, paramenthane hydroperoxide, cumene hydroperoxide, dicumyl peroxide, t-butyl hydroperoxide, di-t-butyl peroxide, and t-hexyl peroxide. Examples of the inorganic peroxide encompass hydrogen peroxide, potassium persulfate, and ammonium persulfate.

In the production of the fine polymer particles (A), a redox initiator can also be used. The redox initiator is an initiator which contains a combination of (i) a peroxide such as an organic peroxide and an inorganic peroxide and (ii) a transition metal salt (such as iron (II) sulfate) and a reducing agent such as sodium formaldehyde sulfoxylate or glucose. Further, as necessary, a chelating agent such as disodium ethylenediaminetetraacetate, and/or as necessary a phosphorus-containing compound such as sodium pyrophosphate may be used in combination.

Using the redox initiator makes it possible to (i) carry out polymerization even at a low temperature at which pyrolysis of the peroxide substantially does not occur and (ii) select a polymerization temperature from a wide range of temperatures. Thus, using the redox initiator is preferable. Out of redox initiators, redox initiators in which organic peroxides such as cumene hydroperoxide, dicumyl peroxide, paramenthane hydroperoxide, and t-butyl hydroperoxide are used as peroxides are preferable. The amount of the initiator used can be within a known range. In a case where the redox initiator is used, the amounts of, for example, the reducing agent used, the transition metal salt used, and the chelating agent used can be within known ranges.

In a case where, in the formation of the elastic body, the graft part, or the surface-crosslinked polymer by polymerization, a polyfunctional monomer is used to introduce a crosslinked structure into the elastic body, the graft part, or the surface-crosslinked polymer, a known chain transfer agent can be used in an amount within a known range. By using the chain transfer agent, it is possible to easily adjust the molecular weight and/or the degree of crosslinking of the resulting elastic body, the resulting graft part, or the resulting surface-crosslinked polymer.

In the production of the fine polymer particles (A), a surfactant can be further used, in addition to the above-described components. The type and the amount of the surfactant used are set within known ranges.

In the production of the fine polymer particles (A), conditions of polymerization such as polymerization temperature, pressure, and deoxygenation can be, as appropriate, conditions within known numerical ranges.

The latex containing the fine polymer particles (A) and the emulsifying agent can be obtained by the above described fine polymer particle (A) production method. That is, the description in (2-3. Fine polymer particle (A) production method) can be applied as the description pertaining to the method for producing the latex.

(1-2-4. Emulsifying Agent)

The emulsifying agent contained in the latex contains a lipophilic part and a hydrophilic part, and the hydrophilic part has a polyoxyethylene group. In the present specification, an “emulsifying agent which contains a lipophilic part and a hydrophilic part and in which the hydrophilic part has a polyoxyethylene group” may also be simply referred to as “emulsifying agent having a polyoxyethylene group”. The origin of the emulsifying agent contained in the latex and having a polyoxyethylene group is not particularly limited. When the latex is obtained by emulsion polymerization of the fine polymer particles (A), the emulsifying agent contained in the latex and having a polyoxyethylene group may be derived from the emulsifying agent used in the production of the fine polymer particles (A).

The lipophilic part has a chemical structure which has high affinity with an organic solvent or the like. The particle surfaces of the fine polymer particles (A) are hydrophobic in large part, and therefore the lipophilic part has high affinity with the fine polymer particles (A). Examples of the lipophilic part encompass parts having aliphatic groups and aromatic groups. Out of these, from the viewpoint of availability, the lipophilic part is preferably a part having an aliphatic group. The aliphatic group that constitutes the lipophilic part may be chain-like or cyclic, and may be saturated or unsaturated. When the aliphatic group is in a chain form, the aliphatic group may be in a straight-chain form or may be in a branched chain form. Examples of the chain aliphatic group encompass alkyl groups and alkenyl groups which have 2 to 20 carbon atoms. Examples of the cyclic aliphatic group encompass cycloalkyl groups which have 3 to 10 carbon atoms. The hydrogen atoms bonding to the chain aliphatic group may be substituted with at least one substituent. Examples of the substituent encompass a halogen atom.

The hydrophilic part has a chemical structure having high affinity with water, and has a polyoxyethylene group (—CH₂—CH₂—O—). From the viewpoint of the stability of emulsion polymerization, in the polyoxyethylene group, the addition mole number (n in the structural formula shown below) of ethylene oxide is preferably 1 to 15, more preferably 1 to 10, more preferably 2 to 10, and particularly preferably 4 to 10.

[symbol]

CH₂—CH₂—O [symbol] ₙ

As the emulsifying agent having a polyoxyethylene group, the following is preferable: an emulsifying agent whose hydrophilic part contains a sulfate ester part (hereinafter, an emulsifying agent whose hydrophilic part contains a sulfate ester part will also be referred to as “sulfur-based emulsifying agent”); or an emulsifying agent whose hydrophilic part contains a phosphoric ester part (hereinafter, an emulsifying agent whose hydrophilic part contains a phosphoric ester part will also be referred to as “phosphorus-based emulsifying agent”). From the viewpoint of easiness in purifying the fine polymer particles (A), the emulsifying agent is more preferably a sulfur-based emulsifying agent whose hydrophilic part contains a sulfate ester part. From the viewpoint of small environmental impact, the emulsifying agent is more preferably a phosphorus emulsifying agent containing a phosphoric ester part. Specific examples of the phosphorus-based emulsifying agent whose hydrophilic part has a polyoxyethylene group and a phosphoric ester part encompass polyoxyethylene alkyl ether phosphoric acid, polyoxyethylene alkyl ether sodium phosphate, and polyoxyethylene alkyl ether potassium phosphate. These emulsifying agents having a polyoxyethylene group may be used alone or in combination of two or more.

(1-2-5. Amount of Fine Polymer Particles (A) and Amount of Emulsifying Agent)

The amount of the fine polymer particles (A) in the latex is not particularly limited, provided that (i) the fine polymer particles (A) can be stably dispersed in the latex and (ii) an agglutinate can be formed in the aqueous phase in the loose agglutinating step described later. From the viewpoint of efficient production of the purified fine polymer particles (A), the amount of the fine polymer particles (A) in the latex is preferably 10% by weight to 50% by weight, more preferably 15% by weight to 50% by weight, more preferably 25% by weight to 50% by weight, and particularly preferably 30% by weight to 50% by weight, with respect to 100% by weight of the latex. When the amount of the fine polymer particles (A) in the latex falls within the above ranges, the purified fine polymer particles (A) can be efficiently produced.

The amount of the emulsifying agent in the latex is not particularly limited, but is preferably as small as possible, provided that the emulsion stability of the fine polymer particles (A) is not interfered with.

(1-2-6. Organic Solvent (B))

The organic solvent (B) is not limited to any particular one, but is preferably an organic solvent which exhibits partial solubility in water. In the present specification, an “organic solvent which exhibits partial solubility in water” is intended to mean an organic solvent which, at 20° C., has solubility of 5% by weight to 40% by weight in water at 20° C. The organic solvent (B) at 20° C. has a solubility, in water at 20° C., of preferably 5% by weight to 40% by weight and more preferably 5% by weight to 30% by weight. In a case where the organic solvent (B) at 20° C. has a solubility, in water at 20° C., of not more than 40% by weight, the fine polymer particles (A) are substantially not flocculated and deposited in the organic solvent (B) when the organic solvent (B) and the latex containing the fine polymer particles (A) and the emulsifying agent are mixed. Therefore, it is advantageously possible to smoothly perform the mixing operation. In a case where the organic solvent (B) at 20° C. has a solubility, in water at 20° C., of not less than 5% by weight, the organic solvent (B) can be sufficiently mixed with the latex containing fine polymer particles (A) and the emulsifying agent. Therefore, it is advantageously possible to smoothly perform the mixing operation. That is, when the organic solvent (B) exhibits partial solubility in water, it is advantageously possible to smoothly perform an operation of mixing the organic solvent (B) and the latex containing the fine polymer particles (A) and the emulsifying agent.

When the organic solvent (B) and the latex containing the fine polymer particles (A) and the emulsifying agent are mixed, the organic solvent (B) is preferably an organic solvent which allows the mixing to be achieved substantially without causing the fine polymer particles (A) to flocculated and deposited in the organic solvent (B). This feature brings about an advantage of being able to smoothly perform an operation of mixing the organic solvent (B) and the latex containing the fine polymer particles (A) and the emulsifying agent.

Specific examples of the organic solvent (B) encompass (i) at least one type of organic solvent selected from the group consisting of esters (such as methyl acetate, ethyl acetate, propyl acetate, and butyl acetate); ketones (such as acetone, methyl ethyl ketone, diethyl ketone, and methyl isobutyl ketone); alcohols (such as ethanol, propanol, isopropanol, and butanol); ethers (such as tetrahydrofuran, tetrahydropyran, dioxane, and diethyl ether); aromatic hydrocarbons (such as benzene, toluene, and xylene); and halogenated hydrocarbons (such as methylene chloride and chloroform) and (ii) a mixture of these. The methyl ethyl ketone has high affinity with an organic solvent (C) (described later) and the resin (D), and is readily available. Therefore, the organic solvent (B) contains methyl ethyl ketone in an amount of preferably not less than 50% by weight, more preferably not less than 75% by weight, and particularly preferably not less than 85% by weight.

(1-2-7. Organic Solvent Mixing Step)

The organic solvent mixing step is a step of mixing (i) the latex containing the fine polymer particles (A) and the emulsifying agent and (ii) the organic solvent (B). It can also be said that the organic solvent mixing step is a step of simply combining (i) the latex containing the fine polymer particles (A) and the emulsifying agent and (ii) the organic solvent (B). In the present specification, the organic solvent mixing step includes neither a step of allowing the mixture obtained by mixing the latex and the organic solvent (B) to stand for not less than 5 minutes nor a step of stirring the mixture for not less than 5 minutes. In other words, in the present specification, the organic solvent mixing step may include a step of allowing the mixture obtained by mixing the latex and the organic solvent (B) to stand for less than 5 minutes and/or the step of stirring the mixture for less than 5 minutes.

A special device or a special method is not required as a device or a method for mixing the latex and the organic solvent (B). A known device or a known method can be used, provided that a favorable mixing state is achieved. When the mixture is allowed to stand after the organic solvent mixing step, examples of a general device encompass a stirring vessel having a stirrer blade. In a case where stirring is performed after the organic solvent mixing step, examples of a general device encompass a stirring vessel having a stirrer blade, a static mixer, and a line mixer (mounted in part of a pipe).

In a case where a stirring vessel having a stirrer blade is used in the organic solvent mixing step, the following may possible: (i) After the latex is introduced in the stirring vessel, the organic solvent (B) is added to the latex while the latex is being stirred. (ii) After the organic solvent (B) is introduced in the stirring vessel, the latex is added to the organic solvent (B) while the organic solvent (B) is being stirred. (iii) While the latex and the organic solvent (B) are being added to an empty stirring vessel together (simultaneously), the mixture in the vessel is stirred.

A suitable amount of the organic solvent (B) used in the organic solvent mixing step varies depending on, for example, the amount of the fine polymer particles (A) in the latex and the type of the fine polymer particles (A), and is not particularly limited. In one or more embodiments, the amount of the organic solvent (B) used in the organic solvent mixing step is preferably 50 parts by weight to 400 parts by weight, more preferably 70 parts by weight to 300 parts by weight, more preferably 70 parts by weight to 200 parts by weight, more preferably 70 parts by weight to 150 parts by weight, more preferably 70 parts by weight to 140 parts by weight, more preferably 70 parts by weight to 130 parts by weight, more preferably 70 parts by weight to 120 parts by weight, and particularly preferably 70 parts by weight to 110 parts by weight, with respect to 100 parts by weight of the latex. In a case where the amount of the organic solvent (B) used in the organic solvent mixing step is not less than 50 parts by weight, there are the following advantages: (i) the fine polymer particles (A) can be stably dispersed in the organic solvent (B); and (ii) the mixture of the latex and the organic solvent (B) tends to have a low viscosity so as to be easy to handle. In a case where the amount of the organic solvent (B) used in the organic solvent mixing step is not more than 400 parts by weight, it is advantageously possible to efficiently remove the organic solvent (B) in the production of the resin composition described later.

The temperatures of the latex and the organic solvent (B) to be subjected to the organic solvent mixing step are not particularly limited, provided that the latex and the organic solvent (B) can be uniformly mixed.

(1-2-8. Mixed State Maintaining Step)

The mixed state maintaining step is a step of performing at least one selected from the group consisting of allowing the mixture obtained in the organic solvent mixing step to stand and stirring the mixture. It can also be said that the mixed state maintaining step is a step of allowing the mixture of the latex and the organic solvent (B) to stand and/or stirring the mixture so as to cause the emulsifying agent having a polyoxyethylene group to be dissociated from the fine polymer particles (A) and move the fine polymer particles (A) into the organic solvent (B).

In the mixed state maintaining step, it is preferable to perform at least one selected from the group consisting of allowing the mixture obtained in the organic solvent mixing step to stand and/or stirring the mixture until the viscosity of the mixture becomes constant.

The inventor of one or more embodiments of the present invention discovered new knowledge below regarding the viscosity of the mixture of the latex and the organic solvent (B). When the organic solvent (B) and the latex containing the fine polymer particles (A) and the straight-chain alkyl benzene are mixed, the viscosity of the mixture is constant, starting immediately after the mixing and even after a certain period of time has elapsed, and does not change. This is presumably because, in a case where the latex contains straight-chain alkyl benzene, substantially the entirety of the fine polymer particles (A) in the latex moves into the organic solvent (B) immediately after the latex and the organic solvent (B) are mixed. However, one or more embodiments of the present invention are not limited to this presumption. Meanwhile, in a case where the organic solvent (B) is mixed with a latex containing fine polymer particles (A) and a phosphorus-based emulsifying agent having a polyoxyethylene group, the viscosity of the mixture rises over time, starting immediately after the mixing. After allowing the mixture to stand and/or stirring the mixture for a predetermined amount of time, the viscosity of the mixture becomes constant and then completely does not change (is saturated).

It should be noted that, in the present specification, “viscosity becoming constant” is intended to mean that the value (%) (|(Vₜ₂−Vₜ₁)|/(V₁−V₀)×100) obtained by dividing the absolute value of the difference (Vₜ₂−Vₜ₁) between the mixture viscosity (Vₜ₁) at a given time point and the viscosity (Vₜ₂) of the mixture that has been allowed to stand and/or stirred for 5 minutes since the time point Vₜ₁ by the difference (V₁−V₀) between the viscosity (V₀) at a time point at the start of the mixing (0 minutes) and the viscosity (V₁) at the saturation time point at which the viscosity completely does not change and multiply the obtained value by 100 is not more than 10%. That is, “viscosity becoming constant” is not intended to mean that the viscosity difference is strictly constant (0). Therefore, it can also be said that “performing at least one selected from the group consisting of allowing the mixture to stand and stirring the mixture until the viscosity of the mixture becomes constant” in the mixed state maintaining step is allowing the mixture to stand and/or stirring the mixture until the viscosity of the mixture obtained in the organic solvent mixing step becomes substantially constant.

Allowing the mixture to stand and/or stirring the mixture until the viscosity of the mixture becomes constant makes it possible to sufficiently dissociate the emulsifying agent having a polyoxyethylene group from the fine polymer particles (A) and sufficiently move the fine polymer particles (A) into the organic solvent (B). This makes it possible to markedly reduce the amount of the fine polymer particles (A) mixed in the aqueous phase (discharged liquid) that has been separated and removed in the separating step described later. The change in the viscosity of the mixture in a case where the emulsifying agent having a polyoxyethylene group is contained is presumably due to the fact that the rate at which the fine polymer particles (A) and the emulsifying agent having a polyoxyethylene group are dissociated is low. However, one or more embodiments of the present invention are not limited to this presumption.

In the mixed state maintaining step, the change in the viscosity of the mixture may be monitored while the mixture of the latex and the organic solvent (B) is being allowed to stand and/or stirred. A method for monitoring the change in the viscosity of the mixture can be achieved by various methods and is not limited to any particular one. For example, it is possible to sample the mixture during the standing and/or stirring in a timely manner, and measure the viscosity of the obtained sample by a viscometer. The method for measuring the viscosity of the mixture using a viscometer will be described later in detail in Examples.

In one or more embodiments, the viscosity of the mixture becomes constant by allowing a mixture of 100 parts by weight of the latex (solid content concentration in the fine polymer particles (A) in 100% by weight of the latex: 10% by weight to 50% by weight) and 50 parts by weight to 400 parts by weight of the organic solvent (B) to stand in a vessel for not less than 30 minutes.

In another embodiment, the viscosity of the mixture becomes constant by stirring a mixture of 100 parts by weight of the latex (solid content concentration in the fine polymer particles (A) in 100% by weight of the latex: 10% by weight to 50% by weight) and 50 parts by weight to 400 parts by weight of the organic solvent (B) in a stirring vessel having a stirrer blade at a stirring speed of 10 rpm to 5000 rpm for not less than 10 minutes.

In the mixed state maintaining step, the amount of time required for the mixture to stand is not particularly limited, and varies depending on, for example, the types of the fine polymer particles (A), the emulsifying agent having a polyoxyethylene group, and the organic solvent (B), the amount (concentration) of the fine polymer particles (A) in the mixture, and the concentration, in the mixture, of the emulsifying agents having a polyoxyethylene group. In one or more embodiments, the amount of time required for the mixture to stand in the mixed state maintaining step is, for example, preferably not less than 30 minutes, more preferably not less than 45 minutes, more preferably not less than 60 minutes, and particularly preferably not less than 120 minutes. Allowing the mixture to stand for not less than 30 minutes makes it possible to sufficiently dissociate the emulsifying agent having a polyoxyethylene group from the fine polymer particles (A) and sufficiently move the fine polymer particles (A) into the organic solvent (B). This makes it possible to markedly reduce the amount of the fine polymer particles (A) mixed in the aqueous phase (discharged liquid) that has been separated and removed in the separating step described later. The upper limit of the amount of time required for the mixture to stand in the mixed state maintaining step is not particularly limited. From the viewpoint of efficiency, the upper limit is, for example, preferably not more than 5 hours and more preferably not more than 2 hours.

In the mixed state maintaining step, a suitable temperature of the mixture is not particularly limited, and varies depending on, for example, the types of the fine polymer particles (A), the emulsifying agent having a polyoxyethylene group, and the organic solvent (B), the solid content concentration of the fine polymer particles (A) in the mixture, and the concentration, in the mixture, of the emulsifying agents having a polyoxyethylene group. In one or more embodiments, the temperature of the mixture to be subjected to the mixed state maintaining step is, for example, preferably 10° C. to 50° C., more preferably 15° C. to 40° C., and more preferably 20° C. to 40° C. In a case where the temperature of the mixture to be subjected to the mixed state maintaining step and/or the temperature of the mixture obtained in the mixed state maintaining step fall(s) within the above ranges, it is advantage possible to sufficiently dissociate the emulsifying agent having a polyoxyethylene group from the fine polymer particles (A). It can also be said that the “temperature of the mixture obtained in the mixed state maintaining step” is the “temperature of the mixture after the mixed state maintaining step”.

It is possible to proceed to carry out the mixed state maintaining step in the device in which the organic solvent mixing step was carried out (for example, a stirring vessel, a static mixer, or a line mixer). Alternatively, it is possible to carry out the mixed state maintaining step in a device different from the device in which the organic solvent mixing step was carried out.

(1-2-9. Loose Agglutinating Step)

The first production method can further include a loose agglutinating step after the mixed state maintaining step. The loose agglutinating step is a step of causing the mixture after the mixed state maintaining step to come into contact with water so as to produce, in an aqueous phase, an agglutinate of the fine polymer particles (A) which agglutinate contains the organic solvent (B). It can also be said that the loose agglutinating step is a step of causing impurities, such as water and the emulsifying agent, to migrate from the mixture of the latex and the organic solvent (B) into an aqueous phase.

By the operation in which the mixture after the mixed state maintaining step and water are brought into contact, part of the organic solvent (B) contained in the mixture is also dissolved in water and becomes an aqueous phase. At the same time, the impurities such as the latex-derived water content and the latex-derived emulsifying agent which are contained in the mixture are also removed and moved into the aqueous phase. Therefore, the mixture is formed such that the fine polymer particles (A) are concentrated in the organic solvent (B) containing water. This produces an agglutinate.

From the viewpoint of preventing partial occurrence of the fine polymer particles (A) that are not agglutinated, the loose agglutinating step is preferably carried out during stirring or under a flowing condition in which flowability equivalent to that during stirring can be obtained. The loose agglutinating step can be carried out by, for example, a batch operation or a continuous operation in a stirring vessel having a stirrer.

The method for bringing the mixture into contact with water is not limited to any particular one, provided that the mixture and water come into contact. For example, it is possible to apply (i-1) a method for continuously adding a constant amount of water to the mixture, (i-2) a method for adding a constant amount of water to the mixture in divided portions, (i-3) a method for adding water all at once to the mixture, (ii-1) a method for continuously adding a constant amount of the mixture to water, (ii-2) a method for adding a constant amount of the mixture to water in divided portions, and (ii-3) a method for adding the mixture all at once to water.

From the viewpoint of efficient production of an agglutinate, it is preferable to continuously supply the mixture and water to a device equipped with a stirring function to bring the mixture and the water into contact with each other and to continuously obtain an agglutinate and an aqueous phase. The shape of the stirrer blade and the device for stirring is not particularly limited. In one or more embodiments, an agglutinate is generally buoyant in an aqueous phase. Therefore, a method for supplying the mixture and water from the bottom part of the stirring vessel and removing the agglutinate and the aqueous phase from the upper part of the stirring vessel is preferable. It should be noted that the bottom part of the device means a position which is at least ⅓ from the bottom or below with respect to the distance from the bottom surface of the device to the liquid surface, and that the upper part of the device means a position which is at least ⅔ from the bottom part or above with respect to the distance from the bottom surface of the device to the liquid surface. By continuously carrying out the loose agglutinating step, it is possible to reduce the size of the device so as to suppress facility costs and improve productivity.

The amount of water to be brought into contact with the mixture in the loose agglutinating step may also vary depending on the type of the fine polymer particles (A), the solid content concentration of the fine polymer particles (A) in the latex, and the type and the amount of the organic solvent (B). The amount of water is preferably 40 parts by weight to 350 parts by weight and more preferably 60 parts by weight to 250 parts by weight, with respect to 100 parts by weight of an organic solvent (B) used in the organic solvent mixing step. In a case where the amount of the water is not less than 40 parts by weight, it is advantageously easy to produce an agglutinate of the fine polymer particles (A). In a case where the amount of the water is not more than 350 parts by weight, the organic solvent (B) concentration in the produced agglutinate falls within a suitable range, and it is thus advantageously easy to re-disperse the agglutinate in the organic solvent (C) in the re-dispersing step described later.

A suitable temperature of the mixture and water to be subjected to the loose agglutinating step is not particularly limited and varies depending on, for example, the types of the fine polymer particles (A), the emulsifying agent, and the organic solvent (B), and the fine polymer particle (A) concentration and the emulsifying agent concentration in the mixture. In one or more embodiments, the temperature of the mixture and water to be subjected to the loose agglutinating step and/or the temperature of the agglutinate and the aqueous phase obtained in the loose agglutinating step are, for example, preferably 10° C. to 50° C., more preferably 15° C. to 40° C., and more preferably 20° C. to 40° C. In a case where the temperature of the mixture and water to be subjected to the loose agglutinating step and/or the temperature of the agglutinate and the aqueous phase obtained in the loose agglutinating step fall(s) within the above ranges, there are advantages that the agglutination state is favorable and the organic solvent used is less likely to be volatilized.

(1-2-10. Separating Step)

The first production method can further include, after the loose agglutinating step, a separating step of separating the agglutinate, which was produced in the loose agglutinating step, from the aqueous phase. By separating the agglutinate produced in the loose agglutinating step from the aqueous phase, the majority of the latex-derived impurities (such as the emulsifying agent and electrolytes) can be removed together with the aqueous phase from the fine polymer particles (A), except for the water content contained in the organic solvent (B) accompanying the agglutinate. This makes it possible to obtain an agglutinate of the fine polymer particles (A) (i.e., purified fine polymer particles (A)) in which the majority of the impurities has been separated and removed.

A method for separating the agglutinate from the aqueous phase is not particularly limited. Examples of the method encompass general filtration methods such as a filtration operation using filter paper, filter cloth, or a metal screen having a relatively coarse mesh size.

The amount of the fine polymer particles (A) contained in the aqueous phase separated and removed in the separating step is preferably not more than 5% by weight, more preferably not more than 3% by weight, more preferably not more than 2% by weight, and particularly preferably not more than 1% by weight with respect to 100% by weight of the aqueous phase. Most preferably, the fine polymer particles (A) are substantially not contained in the aqueous phase.

The permeability of the aqueous phase separated and removed in the separating step is preferably not less than 5%, more preferably not less than 10%, more preferably not less than 15%, more preferably not less than 20%, and particularly preferably not less than 30%. It can be said that the aqueous phase has favorable permeability when the permeability of the aqueous phase is not less than 5%. In many cases, in the aqueous phase which has a permeability of not less than 30%, white turbidity is not visually confirmed. A method for measuring the permeability of the aqueous phase will be described later in detail in Examples.

A suitable temperature of the agglutinate and the aqueous phase to be subjected to the separating step is identical to the suitable temperature of the agglutinate and the aqueous phase obtained in the loose agglutinating step described in the above section (1-2-9. Loose agglutinating step).

(1-2-11. Rinsing Step)

The first production method can further include a step of repeating a cycle selected from the following (i) and (ii) at least once (also referred to as “rinsing step”) after the separating step:
(i) A first cycle including a first step of adding the organic solvent (B) to the agglutinate obtained in the separating step (i.e., agglutinate after the separating step), a second step of causing a mixture obtained in the first step to come into contact with water so as to produce, in an aqueous phase, an agglutinate of the fine polymer particles (A) which agglutinate contains the organic solvent (B), and a third step of separating, from the aqueous phase, the agglutinate obtained in the second step; and
(ii) a second cycle including a first step of adding water to the agglutinate obtained in the separating step, a second step of causing a mixture obtained in the first step to come into contact with the organic solvent (B) so as to produce, in an aqueous phase, an agglutinate of the fine polymer particles (A) which agglutinate contains the organic solvent (B), and a third step of separating, from the aqueous phase, the agglutinate obtained in the second step.

The first production method is a method in which the organic solvent (B) is used to obtain purified fine polymer particles (A) from the latex containing the fine polymer particles (A). In the first production method, the agglutinate of the fine polymer particles (A) obtained in the separating step is a loose agglutinate which has reversibility with respect to coalescence dispersion of the particles. The section [1-3. Agglutinate of fine polymer particles (A)] described later will discuss a loose agglutinate. The agglutinate (i.e., loose agglutinate) obtained in the separating step is, for example, a mass having a size of several centimeters or more. The agglutinate (i.e., loose agglutinate) obtained in the separating step has the following properties: (i) the agglutinate is likely to become a mass which is finer in size in water (but which has a substantially visible size) and (ii) the agglutinate is likely to becomes an extremely fine-sized mass (which has no substantially visible size) in the organic solvent and/or contains fine polymer particles (A) that are likely to be re-dispersed as primary particles. Therefore, by carrying out the rinsing step of adding water or the organic solvent to the agglutinate, it is advantageously possible to efficiently rinse and remove impurities in the agglutinate.

Specifically, in the first cycle in the rinsing step, adding the organic solvent (B) to the agglutinate, for example, causes the agglutinate having a size of several centimeters or more to become an extremely fine mass (a mass having no visible size) and/or causes at least part of the fine polymer particles (A) contained in the agglutinate to be re-dispersed as primary particles. In this case, the impurities inside the agglutinate are released into the organic solvent (B) (first step in the first cycle). Subsequently, bringing the mixture obtained in the first step in the first cycle into contact with water causes the fine polymer particles (A) to agglutinate, so that, for example, an agglutinate having a size of several centimeters or more is regenerated (second step in the first cycle). The amount of the impurities inside the agglutinate can be reduced before and after the first step and the second step in the first cycle.

Furthermore, in the second cycle of the rinsing step, adding water to the agglutinate causes, for example, the agglutinate having a size of several centimeters or more to become a finer mass (which, however, has a substantially visible size). In this case, the impurities inside the agglutinate are released into water (first step in the second cycle). Subsequently, by bringing the mixture and the organic solvent (B) into contact with each other in the first step in the second cycle, the fine mass agglutinate so as to regenerate an agglutinate which has a larger size (e.g., size of several centimeters or more) (second step in the second cycle). The amount of the impurities inside the agglutinate can be reduced before and after the first step and the second step in the second cycle.

As described above, the agglutinate obtained after the rinsing step contains a reduced amount of impurities in comparison with the agglutinate before the rinsing step. Since the agglutinate obtained after the rinsing step is a loose agglutinate, it is possible to reversibly perform (i) causing the fine polymer particles (A) to return to primary particles or become a finer mass and (ii) causing the fine polymer particles (A) to agglutinate or become a larger mass. Therefore, by repeating the rinsing step, it is possible to further reduce the impurity content of the agglutinate.

The agglutinate obtained by a general method for causing the fine polymer particles (A) to agglutinate without the use of an organic solvent (for example, a method using a flocculant) is irreversible with respect to the coalescence dispersion of the fine polymer particles. Therefore, it is difficult to reduce or increase the size of an agglutinate of the fine polymer particles obtained by agglutination by a subsequent operation (such as adding water or the organic solvent). Therefore, even if water or the organic solvent is added to the agglutinate, it is only the surface of the agglutinate that is only rinsed, and it is not easy to rinse and remove the impurities inside the agglutinate.

In the rinsing step, the productivity can be increased by repeating a cycle selected from the first cycle and the second cycle at least once. For example, in order to reduce the amount of impurities such as the emulsifying agent in purified fine polymer particles (A) to be ultimately obtained (e.g., the amounts of P and S derived from the emulsifying agent), it is conceivable to employ as method for increasing the amount of the organic solvent (B) used in the organic solvent mixing step and the amount of water used in the loose agglutinating step. However, such a method, due to the limitation of the capacity of a container, requires a reduction in the amount of fine polymer particles (A) produced, such as reducing the amount of monomers used in the production of the fine polymer particles (A). Meanwhile, in a case where the above-described rinsing step is carried out, it is possible to reduce the amount of impurities such as the emulsifying agent in purified fine polymer particles (A) to be ultimately obtained, without increasing the amount of the organic solvent (B) used in the organic solvent mixing step and the amount of water used in the loose agglutinating step, that is, without decreasing the amount of fine polymer particles (A) produced. That is, by carrying out the rinsing step, it is possible to efficiently produce an agglutinate of the fine polymer particles (A) (i.e., purified fine polymer particles (A)) which contains a further reduced amount of impurities such as the emulsifying agent, more specifically, P and S derived from the emulsifying agent.

The number of repetitions of a cycle selected from the first cycle and the second cycle is not particularly limited. A larger number of cycles allows a further reduction in the amount of impurities contained in the agglutinate. From the viewpoint of obtaining an agglutinate that contains an extremely small amount of impurities, the cycle selected from the first cycle and the second cycle is repeated more preferably two or more times, more preferably three or more times, and particularly preferably four or more times, in the rinsing step. In a case where the cycle selected from the first cycle and the second cycle is repeated at least two times in the rinsing step, it is possible that (i) the first cycle is performed two or more times and the second cycle is not performed, (ii) the second cycle is performed two or more times and the first cycle is not performed, or (iii) the first cycle and the second cycle are each performed once or more times.

(First Step in the First Cycle)

The first step in the first cycle is a step of adding the organic solvent (B) to the agglutinate which has been separated from the aqueous phase. In this step, the agglutinate becomes an extremely fine mass (which has no visible size) and/or at least part of the fine polymer particles (A) contained in the agglutinate is dispersed again as primary particles and the impurities inside the agglutinate are released into the organic solvent (B). Examples of the device and the method for adding the organic solvent (B) to the agglutinate which has been separated from the aqueous phase encompass the device and the method described in the above-described section (1-2-7. Organic solvent mixing step).

A suitable amount of the organic solvent (B) added to the agglutinate in the first step in the first cycle varies depending on, for example, the amount of the fine polymer particles (A) in the agglutinate and the type of the fine polymer particles (A), and is not particularly limited. In one or more embodiments, the amount of the organic solvent (B) to be added to the agglutinate in the first step in the first cycle is preferably 1 part by weight to 400 parts by weight, more preferably 1 part by weight to 300 parts by weight, and more preferably 10 parts by weight to 100 parts by weight, with respect to 100 parts by weight of the agglutinate. In a case where the amount of the organic solvent (B) added to the agglutinate in the first step in the first cycle is not less than 1 part by weight, there are the following advantages: (i) the fine polymer particles (A) can be stably dispersed in the organic solvent (B); and (ii) the mixture of the agglutinate and the organic solvent (B) tends to have a low viscosity so as to be easy to handle. In a case where the amount of the organic solvent (B) to be added to the agglutinate in the first step in the first cycle is not more than 400 parts by weight, it is advantageously possible to reduce the amount of water added in the second step in the first cycle.

The temperatures of the agglutinate and the organic solvent (B) to be subjected to the first step in the first cycle are not particularly limited, provided that the agglutinate and the organic solvent (B) can be uniformly mixed.

(Second Step in First Cycle)

The second step in the first cycle is a step of bringing the mixture obtained in the first step in the first cycle into contact with water. In this step, the agglutinate of the fine polymer particles (A) which agglutinate contains the organic solvent (B) (e.g., the agglutinate having a size of several centimeters or more) is regenerated in the newly generated aqueous phase. It can also be said that this step is a step of causing impurities, such as water and the emulsifying agent, to migrate from the mixture of the agglutinate and the organic solvent (B) into an aqueous phase.

A suitable amount of water to be added to the agglutinate in the second step in the first cycle varies depending on, for example, the amount of the fine polymer particles (A) in the agglutinate and the type of the fine polymer particles (A), and is not particularly limited. In one or more embodiments, the amount of water to be added to the agglutinate in the second step in the first cycle is preferably 50 parts by weight to 500 parts by weight, more preferably 50 parts by weight to 400 parts by weight, and more preferably 50 parts by weight to 300 parts by weight, with respect to 100 parts by weight of the agglutinate. In a case where the amount of water to be added to the agglutinate in the second step in the first cycle is not less than 50 parts by weight, it is advantageously possible to reduce the amount of impurities such as the emulsifying agent in purified fine polymer particles (A) to be ultimately obtained (for example, the amounts of P and S derived from the emulsifying agent). In a case where the amount of water to be added to the agglutinate in the second step in the first cycle is not more than 500 parts by weight, it is advantageously possible to reduce the amount of the organic solvent (B) to be added in the first step in the first cycle. The temperatures of the agglutinate and water subjected to the second step in the first cycle are not particularly limited.

(Third Step in First Cycle)

The third step in the first cycle is a step of separating, from the aqueous phase, the agglutinate obtained in the second step in the first cycle. This step can be carried out similarly to the separating step. The disclosure in the section (1-2-10. Separating step) applies to the device and the method for carrying out this step and to preferable conditions for carrying out this step.

(First Step in Second Cycle)

The first step in the second cycle is a step of adding water to the agglutinate which has been separated from the aqueous phase. In this step, the agglutinate becomes a finer mass (which, however, has a visible size), and the impurities inside the agglutinate are released into water.

A method for adding water to the agglutinate is not limited to any particular one. Examples of the method encompass a method in which water is continuously added to the agglutinate and a method in which water is added all at once.

A device for adding water to the agglutinate is not limited to any particular one. Examples of the device encompass a stirring vessel having a stirrer blade.

In a case of using a stirring vessel having a stirrer blade in the first step in the second cycle, the following may be possible: (i) After the agglutinate is introduced into the stirring vessel, water is added to the agglutinate while the agglutinate is being stirred. (ii) After water is introduced into the stirring vessel, the agglutinate is added to water while the water is being stirred. (iii) While the agglutinate and water are being added together (simultaneously) to an empty stirring vessel, the mixture in the vessel is stirred.

A suitable amount of water to be added to the agglutinate in the first step in the second cycle varies depending on, for example, the amount of the fine polymer particles (A) in the agglutinate and the type of the fine polymer particles (A), and is not particularly limited. In one or more embodiments, the amount of water to be added to the agglutinate in the first step in the second cycle is preferably 50 parts by weight to 500 parts by weight, more preferably 50 parts by weight to 400 parts by weight, and more preferably 50 parts by weight to 300 parts by weight, with respect to 100 parts by weight of the agglutinate. In a case where the amount of water to be added to the agglutinate in the first step in the second cycle is not less than 50 parts by weight, it is advantageously possible to reduce the amount of impurities such as the emulsifying agent in purified fine polymer particles (A) to be ultimately obtained (for example, the amounts of P and S derived from the emulsifying agent). In a case where the amount of water to be added to the agglutinate in the first step in the second cycle is not more than 500 parts by weight, it is advantageously possible to reduce the amount of the organic solvent to be added in the second step in the second cycle. The temperatures of the agglutinate and water subjected to the first step in the second cycle are not particularly limited.

(Second Step in Second Cycle)

The second step in the second cycle is a step of bringing the mixture obtained in the first step in the second cycle into contact with the organic solvent (B). In this step, the fine mass in the mixture are agglutinated so as to regenerate an agglutinate which has a larger size (for example, a size of several centimeters or more).

A method for bringing the mixture into contact with the organic solvent (B) is not limited to any particular one. Examples of the method encompass a method in which the organic solvent (B) is continuously added to the mixture and a method in which the organic solvent (B) is added all at once.

A device for adding the organic solvent (B) to the mixture is not limited to any particular one. For example, the device used in the first step in the second cycle (for example, the stirring vessel having a stirrer blade) can be continued to be used.

A suitable amount of the organic solvent (B) to be added to the mixture in the second step in the second cycle varies depending on, for example, the type of the fine polymer particles (A), the amount of the fine polymer particles (A) in the mixture, and the amount of water in the mixture, and is not particularly limited. In one or more embodiments, the amount of the organic solvent (B) to be added to the mixture in the second step in the second cycle is preferably 1 part by weight to 400 parts by weight, more preferably 1 part by weight to 300 parts by weight, and more preferably 1 part by weight to 10 parts by weight, with respect to 100 parts by weight of water added in the first step in the second cycle. In a case where the amount of the organic solvent (B) is not less than 1 part by weight, it is advantageously easy to produce an agglutinate of the fine polymer particles (A). In a case where the amount of the organic solvent (B) is not more than 400 parts by weight, the organic solvent (B) concentration in the produced agglutinate falls within a suitable range, and it is thus advantageously easy to re-disperse the agglutinate in the organic solvent (C) in the re-dispersing step described later.

A suitable temperature of the mixture and the organic solvent (B) to be subjected to the second step in the second cycle is not particularly limited and varies depending on, for example, the types of the fine polymer particles (A), the emulsifying agent, and the organic solvent (B), and the fine polymer particle (A) concentration and the emulsifying agent concentration in the mixture. In one or more embodiments, the temperature of the mixture and the organic solvent (B) to be subjected to the second step in the second cycle and/or the temperature of the agglutinate and the aqueous phase obtained in the second step in the second cycle are, for example, preferably 10° C. to 50° C., more preferably 15° C. to 40° C., and more preferably 20° C. to 40° C.

In a case where the temperature of the mixture and the organic solvent (B) to be subjected to the second step in the second cycle and/or the temperature of the agglutinate and the aqueous phase obtained in the second step in the second cycle fall(s) within the above ranges, there are advantages that the agglutination state is favorable and the organic solvent used is less likely to be volatilized.

(Third Step in Second Cycle)

The third step in the second cycle is a step of separating, from the aqueous phase, the agglutinate obtained in the second step in the second cycle. This step can be carried out similarly to the separating step. The disclosure in the section (1-2-10. Separating step) applies to the device and the method for carrying out this step and to preferable conditions for carrying out this step.

[1-3. Agglutinate of Fine Polymer Particles (A)]

The agglutinate of the fine polymer particles (A) obtained by the first production method has characteristics below.

(i) A general method for agglutinating the fine polymer particles (A), such as a method in which a flocculant is used or a method in which the latex is heated, will be referred to as a method A. In the method A, the majority of the impurities (such as the emulsifying agent and electrolytes) derived from the production of the latex and the operation of agglutinating the fine polymer particles (A) is, in many cases, adsorbed on the surface of the agglutinate or contained inside the agglutinate. Therefore, in the method A, it is not easy to remove these impurities from the agglutinate even when the agglutinate is to be rinsed with water. In contrast, in the first production method, the impurities derived from the production of the latex and the operation of agglutinating the fine polymer particles (A) are all or mostly liberated from the agglutinate and migrated to the aqueous phase. Therefore, in the first production method, these impurities can be easily removed from the agglutinate.

(ii) The agglutinate obtained by the method A is a solid agglutinate which is difficult to be re-dispersed from the agglutinate to the primary particle state of the fine polymer particles (A), even by using mechanical shearing. In contrast, the agglutinate obtained by the first production method is, for example, mixed, by stirring, with an organic solvent (C) which exhibits affinity with the fine polymer particles (A). Therefore, it is possible to disperse again the majority of the fine polymer particles (A) contained in the agglutinate as primary particles. That is, the agglutinate obtained by the first production method has reversibility in an organic solvent with respect to the coalescence dispersion of the particles. In the present specification, such an “agglutinate having reversibility” is referred to as a “loose agglutinate”.

In a case where the agglutinate obtained in the separating step or the rinsing step is to be subjected to the re-dispersing step and a resin mixing step described later, the amount of the organic solvent (B) contained in the agglutinate is preferably not less than 30% by weight and more preferably not less than 35% by weight, with respect to 100% by weight of the agglutinate. By the agglutinate containing the organic solvent (B), it is possible to favorably carry out the re-dispersing step and the resin mixing step. In a case where the amount of an organic solvent (B) contained in the agglutinate is not less than 30% by weight with respect to 100% by weight of the agglutinate, there are the following advantages: (i) It is possible to shorten a period of time required for the re-dispersing step and the resin mixing step. (ii) It is possible to prevent an irreversible agglutinate from remaining. (iii) As a result of the above (i) and (ii), it is easy to obtain favorable dispersibility of the fine polymer particles (A) in the resin (D).

Meanwhile, the purified fine polymer particles (A) can also be obtained as a dry powder by subjecting the agglutinate to dehydration and/or desolvation and then further drying the agglutinate. By, before the agglutinate is dried, rinsing the agglutinate with water that does not contain the organic solvent (B), it is possible to prevent the coalescence of the particles during drying. By this operation, it is possible to obtain a dry powder of purified fine polymer particles (A) which contain extremely few impurities.

(1-3-1. Element Content)

The agglutinate obtained by the first production method contains S in an amount of preferably not more than 1000 ppm, more preferably not more than 500 ppm, more preferably not more than 200 ppm, and particularly preferably not more than 100 ppm, with respect to the weight of the agglutinate. The agglutinate obtained by the first production method contains P in an amount of preferably not more than 1000 ppm, more preferably not more than 500 ppm, more preferably not more than 200 ppm, and particularly preferably not more than 100 ppm, with respect to the weight of the agglutinate. The agglutinate obtained by the first production method contains S and P in a total amount of preferably not more than 2000 ppm, more preferably not more than 1000 ppm, more preferably not more than 400 ppm, more preferably not more than 200 ppm, and particularly preferably not more than 100 ppm, with respect to the weight of the agglutinate. A lower amount(s) of S and/or P contained in the agglutinate obtained by the first production method advantageously lead(s) to less adverse effect on the long-term reliability of the resin composition mixed with the resin (D). The amount(s) of S and/or P contained in the agglutinate obtained by the first production method can also be referred to as the amount of impurities (contaminant) contained in the agglutinate.

In a case where the agglutinate obtained by the first production method contains S and/or P, the origin of these elements is not particularly limited. S and/or P in the agglutinate can be derived from (i) the emulsifying agent used in the production of the fine polymer particles (A) or (i) water and the monomers used in the production of the fine polymer particles (A) and a small amount of elements contained in the organic solvent (B). The amount(s) of S and/or P contained in the agglutinate obtained by the first production method can be measured using, for example, an X-ray fluorescence analyzer, a liquid chromatography, or an ICP emission spectrometer.

[1-4. Resin Composition Production Method]

A resin composition production method in accordance with one or more embodiments of the present invention includes: the re-dispersing step of re-dispersing, in the organic solvent (C), the agglutinate separated from the aqueous phase (for example, an agglutinate separated in the separating step or the rinsing step); and the resin mixing step of mixing the resin (D) with the dispersion solution obtained in the re-dispersing step.

It can also be said that the resin composition production method in accordance with one or more embodiments of the present invention includes, as a step, the purified fine polymer particle (A) production method (first production method) in accordance with one or more embodiments of the present invention. In the resin composition production method in accordance with one or more embodiments of the present invention, an agglutinate of the purified fine polymer particles (A) is produced as an intermediate product.

In the resin composition production method in accordance with one or more embodiments of the present invention, the agglutinate of the purified fine polymer particles (A) is used to obtain a resin composition through the re-dispersing step and the resin mixing step. Therefore, it is advantageously possible to provide, efficiently and with a small environmental load, a resin composition which has few impurities and which has excellent dispersibility of the fine polymer particles (A). “Being able to efficiently provide a resin composition” is also referred to as “improving productivity”. In the resin composition production method in accordance with one or more embodiments of the present invention, it is possible to continuously carry out the organic solvent mixing step, the mixed state maintaining step, the loose agglutinating step, the separating step, the re-dispersing step, and the resin mixing step. (It should be noted that the rinsing step may be optionally carried out between the separating step and the re-dispersing step). Therefore, resin composition production method in accordance with one or more embodiments of the present invention can be a continuous production method suitable for producing a few types of products in a large amount.

The following description will discuss the steps relating to the resin composition production method in accordance with one or more embodiments of the present invention. For matters other than those detailed below, the disclosures in the sections (1-2. Purified fine polymer particle (A) production method) and the section (1-3. Agglutinate) apply as appropriate.

(1-4-1. Re-Dispersing Step)

The re-dispersing step is a step of re-dispersing, in the organic solvent (C), the agglutinate that has been separated in the separating step or the rinsing step. It can also be said that the re-dispersing step is a step of adding the organic solvent (C) to the agglutinate that has been separated in the separating step or the rinsing step and then mixing the resultant mixture. By the re-dispersing step, it is possible to obtain a dispersion solution in which the purified fine polymer particles (A) in the agglutinate are dispersed substantially in the form of primary particles in the organic solvent (C).

Examples of the organic solvent (C) are not limited to any particular one, and encompass any organic solvent in which the fine polymer particles (A) can be re-dispersible. The organic solvent (C) can be constituted by one type of organic solvent or can be a mixture of two or more types of organic solvents.

Specific examples of the organic solvent (C) encompass: the solvents exemplified as the organic solvent (B) and aliphatic hydrocarbons (for example, hexane, heptane, octane, cyclohexane, and ethylcyclohexane); and a mixture of these solvents. From the viewpoint of further securing the re-dispersibility of the agglutinate, it is preferable to use an organic solvent of the same type as the organic solvent (B) used in the organic solvent mixing step.

The amount of the organic solvent (C) used in the re-dispersing step is not particularly limited. The amount may be set, as appropriate, depending on, for example, the type and the amount of the fine polymer particles (A) contained in the agglutinate, the type and the amount of the organic solvent (B) contained in the agglutinate, and the type of the organic solvent (C). In one or more embodiments, the amount of the organic solvent (C) used in the re-dispersing step is preferably 100 parts by weight to 500 parts by weight, more preferably 150 parts by weight to 400 parts by weight, more preferably 200 parts by weight to 350 parts by weight, and particularly preferably 250 parts by weight to 300 parts by weight, with respect to 100 parts by weight of the agglutinate. In a case where the amount of the organic solvent (C) used in the re-dispersion step is not less than 100 parts by weight with respect to 100 parts by weight of the agglutinate, there are the following advantages: (i) It is easy for the fine polymer particles (A) to be uniformly dispersed in the organic solvent (C). (ii) A mass of the agglutinate is prevented from remaining. (iii) The dispersion solution tends to have a low viscosity so as to be easy to handle. In a case where the amount of the organic solvent (C) used in the re-dispersion step is not more than 500 parts by weight, it is advantageously possible to efficiently evaporate and distill off final volatile components.

A device and a method for mixing the agglutinate and the organic solvent (C) do not need to be a special device or a special method. The agglutinate and the organic solvent (C) can be mixed using a device equipped with a general stirring mixing function.

Suitable temperatures of the agglutinate and the organic solvent (C) to be subjected to the re-dispersing step are not particularly limited. In one or more embodiments, the temperatures of the agglutinate and the organic solvent (C) to be subjected to the re-dispersing step and/or the temperature of the dispersion solution obtained in the re-dispersing step is/are, for example, preferably 10° C. to 50° C., more preferably 15° C. to 40° C., and more preferably 20° C. to 40° C. In a case where the temperatures of the agglutinate and the organic solvent (C) to be subjected to the re-dispersing step and/or the temperature of the dispersion solution obtained in the re-dispersing step fall(s) within the above ranges, the following advantages are achieved. That is, in the obtained dispersion solution, the fine polymer particles (A) are favorably dispersed in the organic solvent (C), and the organic solvent used is less likely to be volatilized.

(1-4-2. Resin Mixing Step)

The resin mixing step is a step of mixing the resin (D) with the dispersion solution obtained in the re-dispersing step. The resin mixing step makes it possible to obtain a resin composition in which the fine polymer particles (A) are dispersed substantially in the form of primary particles in the resin (D) and which hardly contains latex-derived impurities (such as the emulsifying agent and electrolytes).

(1-4-3. Resin (D))

The resin (D) is not limited to any particular one, but is preferably a thermosetting resin. The thermosetting resin preferably includes at least one type selected from the group consisting of: resins each containing a polymer obtained by polymerization of an ethylenically unsaturated monomer; epoxy resins; phenolic resins; polyol resins; and amino-formaldehyde resins (melamine resins). Examples of the thermosetting resin also encompass resins each containing a polymer obtained by polymerization of an aromatic polyester raw material. Examples of the aromatic polyester raw material encompass radical-polymerizable monomers (such as an aromatic vinyl compound, a (meth)acrylic acid derivative, a vinyl cyanide compound, and a maleimide compound), dimethyl terephthalate, and alkylene glycol. These thermosetting resins may be used alone or in combination of two or more.

(Ethylenically Unsaturated Monomer)

The ethylenically unsaturated monomer is not limited to any particular one, provided that the ethylenically unsaturated monomer has at least one ethylenically unsaturated bond in its molecule.

Examples of the ethylenically unsaturated monomer encompass acrylic acid, α-alkyl acrylic acids, α-alkyl acrylic acid esters, β-alkyl acrylic acids, β-alkyl acrylic acid esters, methacrylic acid, esters of acrylic acid, esters of methacrylic acid, vinyl acetate, vinyl esters, unsaturated esters, polyunsaturated carboxylic acids, polyunsaturated esters, maleic acid, maleic acid esters, maleic anhydride, and acetoxy styrene. These ethylenically unsaturated monomers may be used alone or in combinations of two or more.

(Epoxy Resins)

The epoxy resin is not particularly limited, provided that the epoxy resin contains at least one epoxy bond per molecule.

Specific examples of the epoxy resins encompass bisphenol A epoxy resin, bisphenol F epoxy resin, bisphenol AD epoxy resin, bisphenol S epoxy resin, glycidyl ester type epoxy resin, glycidyl amine type epoxy resin, novolac type epoxy resin, glycidyl ether epoxy resin of bisphenol A propylene oxide adduct, hydrogenated bisphenol A (or F) epoxy resin, fluorinated epoxy resin, rubber-modified epoxy resin containing polybutadiene or NBR, flame-resistant epoxy resin such as glycidyl ether of tetrabromo bisphenol A, p-oxybenzoic acid glycidyl ether ester type epoxy resin, m-aminophenol type epoxy resin, diaminodiphenylmethane-based epoxy resin, urethane-modified epoxy resin containing urethane bond, various types of alicyclic epoxy resin, glycidyl ether of a polyhydric alcohol, hydantoin-type epoxy resin, epoxidized unsaturated polymer such as petroleum resin, and amino-containing glycidyl ether resin. Examples of the polyhydric alcohol encompass N,N-diglycidyl aniline, N,N-diglycidyl-o-toluidine, triglycidyl isocyanurate, polyalkylene glycol diglycidyl ether, and glycerin. Other examples of the epoxy resins encompass an epoxy compound obtained by causing an addition reaction between one of the above epoxy resins and e.g., a bisphenol A (or F) or a polybasic acid. The epoxy resins are not limited to these examples, and a generally used epoxy resin can be used. These epoxy resins may be used alone or in combination of two or more.

Out of these epoxy resins, epoxy resins each of which has at least two epoxy groups in one molecule are preferable in that, e.g., such resins have high reactivity during curing of the resin composition and make it easy for an obtained cured product to create a three-dimensional mesh. In addition, out of the epoxy resins each of which has at least two epoxy groups in one molecule, epoxy resins each of which contains a bisphenol type epoxy resin as a main component are preferable, because they are economical and easily available.

(Phenolic Resins)

The phenolic resins are not limited to any particular ones, provided that the phenolic resins are each a compound obtained through a reaction between a phenol and an aldehyde. The phenol is not limited to any particular one, and examples thereof encompass phenols such as phenol, ortho-cresol, meta-cresol, para-cresol, xylenol, para-tertiary butylphenol, para-octylphenol, para-phenylphenol, bisphenol A, bisphenol F, and resorcin. In particular, phenol and cresol are preferred as the phenol.

The aldehyde is not limited to any particular one, and examples thereof encompass formaldehyde, acetaldehyde, butylaldehyde, and acrolein, and mixtures thereof. Alternatively, substances which are sources of the above aldehydes or solutions of the above aldehydes can be used. The aldehyde is preferably formaldehyde because an operation for reacting the phenol and the aldehyde is easy.

The molar ratio (F/P) between the phenol (P) and the aldehyde (F) in a reaction between the phenol and the aldehyde (such a molar ratio may be hereinafter referred to as a “reaction molar ratio”) is not limited to any particular one. In a case where an acid catalyst is used in the reaction, the reaction molar ratio (F/P) is preferably 0.4 to 1.0, more preferably 0.5 to 0.8. In a case where an alkali catalyst is used in the reaction, the reaction molar ratio (F/P) is preferably 0.4 to 4.0, more preferably 0.8 to 2.5. In a case where the reaction molar ratio is equal to or higher than the above lower limit, a yield is less likely to excessively decrease and the resulting phenolic resin is less likely to have a low molecular weight. On the contrary, in a case where the reaction molar ratio is equal to or lower than the above upper limit, the phenolic resin is less likely to have an excessively high molecular weight and an excessively high softening point, and it is therefore possible to achieve sufficient flowability during heating. Furthermore, in a case where the reaction molar ratio is equal to or lower than the above upper limit, the molecular weight is easily controlled, and gelation may be less likely to occur or a partially gelatinized product may be less likely to be formed, each of which results from the conditions under which the reaction takes place.

(Polyol Resins)

The polyol resins are each a compound containing two or more active hydrogens as its terminal group(s), and are each bi- or more functional polyol with a molecular weight of about 50 to 20,000. Examples of the polyol resins encompass aliphatic alcohols, aromatic alcohols, polyether type polyols, polyester type polyols, polyolefin polyols, and acrylic polyols.

The aliphatic alcohols may be dihydric alcohols or trihydric or higher polyhydric alcohols (such as trihydric alcohols or tetrahydric alcohols). Examples of the dihydric alcohols encompass: alkylene glycols (in particular, alkylene glycols having about 1 to 6 carbon atoms) such as ethylene glycol, propylene glycol, 1,3-propanediol, 1,3-butanediol, 1,4-butanediol, 1,5-pentanediol, 1,6-hexanediol, 3-methyl-1,5-pentanediol, and neopentylglycol; and substances obtained through dehydrogenative condensation of two or more molecules (e.g., about two to six molecules) of any of the above alkylene glycols (such as diethylene glycol, dipropylene glycol, and tripropylene glycol). Examples of the trihydric alcohols encompass glycerin, trimethylolpropane, trimethylolethane, and 1,2,6-hexanetriol (in particular, trihydric alcohols having about 3 to 10 carbon atoms). Examples of the tetrahydric alcohols encompass pentaerythritol and diglycerin. Other examples encompass saccharides such as monosaccharides, oligosaccharides, and polysaccharides.

Examples of the aromatic alcohols encompass: bisphenols such as bisphenol A and bisphenol F; biphenyls such as dihydroxybiphenyl; polyhydric phenols such as hydroquinone and phenol-formaldehyde condensate; and naphthalenediol.

Examples of the polyether type polyols encompass: random copolymers and block copolymers obtained by ring-opening polymerization of ethylene oxide, propylene oxide, butylene oxide, styrene oxide, or the like in the presence of one or more active-hydrogen-containing initiators; and mixtures of these copolymers. Examples of the active-hydrogen-containing initiators used for the ring-opening polymerization to obtain the polyether type polyols encompass diols such as ethylene glycol, diethylene glycol, propylene glycol, dipropylene glycol, 1,3-butanediol, 1,4-butanediol, 1,6-hexanediol, neopentylglycol, and bisphenol A; triols such as trimethylolethane, trimethylolpropane, and glycerin; saccharides such as monosaccharides, oligosaccharides, and polysaccharides; sorbitol; and amines such as ammonia, ethylenediamine, urea, monomethyl diethanolamine, and monoethyl diethanolamine.

Examples of the polyester type polyols encompass polymers obtained by, in the presence of an esterification catalyst at a temperature falling within the range of 150° C. to 270° C., polycondensation of, for example, (i) a polybasic acid, such as maleic acid, fumaric acid, adipic acid, sebacic acid, phthalic acid, dodecanedioic acid, isophthalic acid, or azelaic acid, and/or an acid anhydride thereof and (ii) a polyhydric alcohol such as ethylene glycol, propylene glycol, 1,4-butanediol, 1,6-hexanediol, diethylene glycol, dipropylene glycol, neopentylglycol, or 3-methyl-1,5-pentanediol. Examples of the polyester type polyols further encompass (i) polymers obtained by ring-opening polymerization of F-caprolactone, valerolactone, or the like; and (ii) active hydrogen compounds containing two or more active hydrogens, such as polycarbonate diol and castor oil.

Examples of the polyolefin type polyols encompass polybutadiene polyol, polyisoprene polyol, and hydrogenated versions thereof.

Examples of the acrylic polyols encompass: copolymers of, for example, (i) a hydroxyl group-containing monomer such as hydroxyethyl (meth)acrylate, hydroxybutyl (meth)acrylate, or vinylphenol and (ii) a general-purpose monomer such as n-butyl (meth)acrylate or 2-ethylhexyl (meth)acrylate; and mixtures thereof.

Out of these polyol resins, the polyether type polyols are preferred, because the resin composition to be obtained has a lower viscosity and has excellent workability, and the resin composition can provide a cured product which is well balanced between its hardness and toughness. Further, out of these polyol resins, the polyester type polyols are preferred, because the resin composition to be obtained can provide a cured product which has excellent adhesiveness.

(Amino-Formaldehyde Resins)

The amino-formaldehyde resins are not limited to any particular ones, provided that the amino-formaldehyde resins are each a compound obtained through a reaction between an amino compound and an aldehyde in the presence of an alkaline catalyst. Examples of the amino compound encompass: melamine; 6-substituted guanamines such as guanamine, acetoguanamine, and benzoguanamine; amine-substituted triazine compounds such as CTU guanamine (3,9-bis[2-(3,5-diamino-2,4,6-triazaphenyl)ethyl]-2,4,8,10-tetraoxaspiro[5,5]undecane) and CMTU guanamine (3,9-bis[(3,5-diamino-2,4,6-triazaphenyl)methyl]-2,4,8,10-tetraoxaspiro[5,5]undecane); and ureas such as urea, thiourea, and ethyleneurea. Examples of the amino compound also encompass: (a) substituted melamine compounds which are different from melamine in that the hydrogen of an amino group is substituted by an alkyl group, an alkenyl group, and/or a phenyl group (described in Specification of U.S. Pat. No. 5,998,573 (a Japanese family member thereof: Japanese Patent Application Publication Tokukaihei No. 9-143238)); and (b) substituted melamine compounds which are different from melamine in that the hydrogen of an amino group is substituted by a hydroxyalkyl group, a hydroxyalkyloxyalkyl group, and/or an aminoalkyl group (described in Specification of U.S. Pat. No. 5,322,915 (a Japanese family member thereof: Japanese Patent Application Publication Tokukaihei No. 5-202157)). Out of the above-listed compounds, melamine, guanamine, acetoguanamine and benzoguanamine, which are polyfunctional amino compounds, are preferable, and melamine is particularly preferable, as the amino compound, because they are industrially produced and inexpensive. The above-listed amino compounds may be used alone or in combination of two or more. In addition to these amino compounds, any of (i) phenols, such as phenol, cresol, alkylphenol, resorcin, hydroquinone, and/or pyrogallol (ii) anilines, and the like may be used.

Examples of the aldehyde encompass formaldehyde, paraformaldehyde, acetaldehyde, benzaldehyde, and furfural. Preferred aldehydes are formaldehyde and paraformaldehyde, because they are inexpensive and well react with the foregoing amino compound. In producing an amino-formaldehyde resin, the amount of the aldehydes to be used is preferably an amount-of-substance that causes an effective aldehyde group to be 1.1 mol to 6.0 mol and particularly preferably an amount-of-substance that causes an effective aldehyde group to be 1.2 mol to 4.0 mol, with respect to 1 mol of the amino compound.

(1-4-4. Physical Properties of Resin (D))

The resin (D) is not particularly limited in terms of the properties thereof. The resin (D) preferably has a viscosity of 100 mPa·s to 1,000,000 mPa·s at 25° C. The viscosity of the resin (D) is more preferably not more than 50,000 mPa·s, more preferably not more than 30,000 mPa·s, and particularly preferably not more than 15,000 mPa·s, at 25° C. According to the above feature, the resin (D) has an advantage of having excellent flowability. It can also be said that the resin (D) having a viscosity of 100 mPa·s to 1,000,000 mPa·s at 25° C. is a liquid.

As the flowability of the resin (D) becomes greater, in other words, as the viscosity of the resin (D) becomes lower, it becomes more difficult to disperse, in the resin (D), the fine polymer particles (A) in the form of primary particles. Conventionally, it has been extremely difficult to disperse, in the resin (D) having a viscosity of not more than 1,000,000 mPa·s at 25° C., the fine polymer particles (A) in the form of the primary particles. However, with the resin composition production method in accordance with one or more embodiments of the present invention, it is possible to obtain a resin composition in which the fine polymer particles (A) having the above feature are favorably dispersed in the resin (D) having a viscosity of not more than 1,000,000 mPa·s at 25° C.

Further, the viscosity of the resin (D) is more preferably not less than 100 mPa·s, more preferably not less than 500 mPa·s, more preferably not less than 1000 mPa·s, and particularly preferably not less than 1500 mPa·s at 25° C. With the above feature, it is possible to prevent the fusion between the fine polymer particles (A) by the resin (D) entering the fine polymer particles (A).

The resin (D) may have a viscosity of more than 1,000,000 mPa·s. The resin (D) may be a semisolid (semiliquid) or may be alternatively a solid. In a case where the resin (D) has a viscosity of more than 1,000,000 mPa·s, a resin composition to be obtained is advantageously less sticky and easy to handle.

The resin (D) has an endothermic peak at preferably not higher than 25° C., more preferably not higher than 0° C., in its differential scanning calorimetry (DSC) thermogram. According to the above feature, the resin (D) has an advantage of having excellent flowability.

(1-4-5. Blending Ratio Between Fine Polymer Particles (A) and Resin (D))

In the resin mixing step, the blending ratio between the fine polymer particles (A) in the dispersion solution and the resin (D) mixed with the dispersion solution is not particularly limited. In one or more embodiments, where the total of resin (D) and the fine polymer particles (A) in the dispersion solution is 100% by weight, it is preferable that the fine polymer particles (A) is 10% by weight to 50% by weight and the resin (D) is 50% by weight to 90% by weight, it is more preferable that the fine polymer particles (A) is 25% by weight to 40% by weight and the resin (D) is 60% by weight to 75% by weight, and it is more preferable that the fine polymer particles (A) is 30% by weight to 40% by weight and the resin (D) is 60% by weight to 70% by weight. In a case where the blending ratio between the fine polymer particles (A) and the resin (D) is arranged as described above, the resin composition advantageously has favorable flowability after the volatile components are distilled off.

A device and a method for mixing the dispersion solution and the resin (D) do not need to be a special device or a special method. The dispersion solution and the resin (D) can be mixed using a device equipped with a general stirring mixing function.

A suitable temperature of the dispersion solution and the resin (D) to be subjected to the resin mixing step is not particularly limited. In one or more embodiments, the temperature of the dispersion solution and the resin (D) to be subjected to the resin mixing step and/or the temperature of the resin composition obtained in the resin mixing step is/are, for example, preferably 10° C. to 80° C., more preferably 15° C. to 80° C., and more preferably 20° C. to 80° C. In a case where the temperature of the dispersion solution and the resin (D) to be subjected to the resin mixing step and/or the temperature of the resin composition obtained in the resin mixing step fall(s) within the above ranges, it is advantageously easy to perform the mixing.

(1-4-6. Distilling Step)

The resin composition production method in accordance with one or more embodiments of the present invention can further include a distilling step which is carried out after the resin mixing step and in which the volatile components such as the organic solvent (B), the organic solvent (C), and water are distilled off from the mixture (resin composition) obtained by mixing the dispersion solution and the resin (D).

A known method can be applied as a method for distilling off the volatile components. Examples of the method encompass a method in which the mixture is introduced into the vessel and is distilled off under reduced pressure by heating, a method in which the dried gas and the mixture are subjected to countercurrent contact in the vessel, a method of a continuous type in which a thin-film evaporator is used, and a method in which an extruder including a devolatilization mechanism or a continuous stirring vessel is used. Conditions such as the required time and the temperature when the volatile components are distilled can be selected as appropriate, provided that the quality of the resin composition is not compromised. In addition, the amount of the volatile components remaining in the resin composition can be selected as appropriate according to the purpose of using the resin composition, provided that no issues arise.

A resin composition production method in accordance with one or more embodiments of the present invention includes the resin mixing step of mixing, with the resin (D), the agglutinate which has been separated in the separating step or the rinsing step. In the resin composition production method in accordance with one or more embodiments of the present invention, which includes the resin mixing step of mixing the agglutinate with the resin (D), the agglutinate is directly mixed with the resin (D) without carrying out the re-dispersing step, that is, without re-dispersing, in the organic solvent (C), the agglutinate which has been obtained in the separating step or the rinsing step. The resin composition in accordance with one or more embodiments of the present invention can also be obtained by such a production method.

[1-5. Resin Composition]

According to the resin composition obtained by the resin composition production method in accordance with one or more embodiments of the present invention, the fine polymer particles (A) are uniformly dispersed in the form of primary particles in the resin (D), and the amount of impurities is small.

The resin composition obtained by the resin composition production method in accordance with one or more embodiments of the present invention can, as needed, contain any component other than the fine polymer particles (A) and the resin (D). Examples of said any other component encompass: anti-blocking agents; curing agents; coloring agents such as pigments and colorants; extenders; ultraviolet ray absorbing agents; antioxidants; heat stabilizers (antigelling agents); plasticizing agents; leveling agents; defoaming agents; silane coupling agents; antistatic agents; flame retardants; lubricants; viscosity reducers; shrinkage reducing agents; inorganic filler; organic filler; thermoplastic resins; desiccants; and dispersion agents.

Said any other component can be added, as appropriate, during any step in the resin composition production method in accordance with one or more embodiments of the present invention. For example, the additive can be added to the dispersion solution and/or the resin (D) in the resin mixing step.

The resin composition obtained by the resin composition production method in accordance with one or more embodiments of the present invention can further contain a known thermosetting resin other than the resin (D), or can further contain a known thermoplastic resin.

A cured product obtained by curing the resin composition obtained by the resin composition production method in accordance with one or more embodiments of the present invention has high dispersion stability of the fine polymer particles (A) and few impurities. The cured product obtained by curing the resin composition obtained by the resin composition production method in accordance with one or more embodiments of the present invention is also one or more embodiments of the present invention.

The resin composition obtained by the resin composition production method in accordance with one or more embodiments of the present invention can be used in various applications, and the applications are not limited to any particular ones. The resin composition is preferably used in applications such as, for example, adhesive agents, coating materials, binders for reinforcement fibers, composite materials, molding materials for 3D printers, sealants, electronic substrates, ink binders, wood chip binders, binders for rubber chips, foam chip binders, binders for castings, rock mass consolidation materials for floor materials and ceramics, and urethane foams. Examples of the urethane foams encompass automotive seats, automotive interior parts, sound absorbing materials, damping materials, shock absorbers (shock absorbing materials), heat insulating materials, and floor material cushions for construction. The resin composition is more preferably used for, out of the above applications, adhesive agents, coating materials, binders for reinforcement fibers, composite materials, molding materials for 3D printers, sealants, and electronic substrates.

### Embodiment 2

[2. Purified Fine Polymer Particle (A) Production Method (Second Production Method)]

One or more embodiments of the present invention provide a novel method which can efficiently produce an agglutinate of fine polymer particles (A) containing a reduced amount of impurities.

A purified fine polymer particle (A) production method in accordance with one or more embodiments of the present invention includes: an organic solvent mixing step of mixing an organic solvent (B) and a latex that contains fine polymer particles (A) and an emulsifying agent;
a loose agglutinating step of causing a mixture obtained in the organic solvent mixing step to come into contact with water so as to produce, in an aqueous phase, an agglutinate of the fine polymer particles (A) which agglutinate contains the organic solvent (B); and
a separating step of separating the agglutinate from the aqueous phase, in which
the method further includes a step of repeating a cycle selected from (i) and (ii) below at least once after the separating step.
(i) A first cycle including a first step of adding the organic solvent (B) to the agglutinate obtained in the separating step, a second step of causing a mixture obtained in the first step to come into contact with water so as to produce, in an aqueous phase, an agglutinate of the fine polymer particles (A) which agglutinate contains the organic solvent (B), and a third step of separating, from the aqueous phase, the agglutinate obtained in the second step; and
(ii) a second cycle including a first step of adding water to the agglutinate obtained in the separating step, a second step of causing a mixture obtained in the first step to come into contact with the organic solvent (B) so as to produce, in an aqueous phase, an agglutinate of the fine polymer particles (A) which agglutinate contains the organic solvent (B), and a third step of separating, from the aqueous phase, the agglutinate obtained in the second step.

In the present specification, it can also be said that the “purified fine polymer particle (A) production method” is a “method for purifying fine polymer particles (A)”. The purified fine polymer particle (A) production method in accordance with one or more embodiments of the present invention may also be referred to as “second production method”.

In the second production method, by carrying out the rinsing step in which a cycle selected from the first cycle and the second cycle is repeated at least once after the separating step, it is possible to efficiently produce an agglutinate of the fine polymer particles (A) (i.e., purified fine polymer particles (A)) which contains a further reduced amount of impurities such as the emulsifying agent, more specifically, P and S derived from the emulsifying agent.

The following description will discuss an emulsifying agent used in the second production method and the element contents of the obtained agglutinate. For matters other than those detailed below, the descriptions of the raw materials (components) of Embodiment 1 and the steps will be applied as appropriate.

(Emulsifying Agent)

In the second production method, the emulsifying agent contained in the latex can be a known emulsifying agent (dispersion agent). Examples of the known emulsifying agent encompass anionic emulsifying agents, nonionic emulsifying agents, polyvinyl alcohols, alkyl-substituted celluloses, polyvinylpyrrolidone, and polyacrylic acid derivatives. Examples of the anionic emulsifying agent encompass sulfur-based emulsifying agents, phosphorus-based emulsifying agents, sarcosine acid-based emulsifying agents, and carboxylic acid-based emulsifying agents. Examples of the sulfur-based emulsifying agent encompass sodium dodecylbenzenesulfonate (abbreviated as SDBS). Examples of the phosphorus-based emulsifying agent encompass sodium polyoxyethylene lauryl ether phosphate.

From the viewpoint of environmental impact, the emulsifying agent contained in the latex preferably contains a lipophilic part and a hydrophilic part, and the hydrophilic part has a polyoxyethylene group in the second production method. From the viewpoint of easiness in purifying the fine polymer particles (A), the emulsifying agent is more preferably a sulfur-based emulsifying agent whose hydrophilic part contains a sulfate ester part. From the viewpoint of small environmental impact, the emulsifying agent is more preferably a phosphorus emulsifying agent containing a phosphoric ester part. The description in the section (1-2-4. Emulsifying agent) applies to the description of the emulsifying agent which contains a lipophilic part and a hydrophilic part having a polyoxyethylene group.

(Element Content of Agglutinate)

The agglutinate obtained by the second production method contains S in an amount of preferably not more than 500 ppm, more preferably not more than 200 ppm, more preferably not more than 100 ppm, and particularly preferably not more than 50 ppm, with respect to the weight of the agglutinate. The agglutinate obtained by the second production method contains P in an amount of preferably not more than 500 ppm, more preferably not more than 200 ppm, more preferably not more than 100 ppm, and particularly preferably not more than 50 ppm, with respect to the weight of the agglutinate. The agglutinate obtained by the second production method contains S and P in a total amount of preferably not more than 1000 ppm, more preferably not more than 400 ppm, more preferably not more than 200 ppm, more preferably not more than 100 ppm, and more preferably not more than 50 ppm, and particularly preferably not more than 25 ppm, with respect to the weight of the agglutinate. A lower amount(s) of S and/or P contained in the agglutinate obtained by the second production method advantageously lead(s) to less adverse effect on the long-term reliability (long-term stability) of the resin composition obtained by mixing the agglutinate and the resin (D). The amount(s) of S and/or P contained in the agglutinate obtained by the second production method can also be referred to as the amount of impurities (contaminant) contained in the agglutinate.

In a case where the agglutinate obtained by the second production method contains S and/or P, the origin of these elements is not particularly limited. S and/or P in the agglutinate can be derived from (i) the emulsifying agent used in the production of the fine polymer particles (A) or (i) water and the monomers used in the production of the fine polymer particles (A) and a small amount of elements contained in the organic solvent (B). The amount(s) of S and/or P contained in the agglutinate obtained by the second production method can be measured using, for example, an X-ray fluorescence analyzer, a liquid chromatography, or an ICP emission spectrometer.

One or more embodiments of the present invention may include features below.

<1> A method for producing purified fine polymer particles (A), including: an organic solvent mixing step of mixing an organic solvent (B) and a latex that contains fine polymer particles (A) and an emulsifying agent; and
a mixed state maintaining step of performing at least one selected from the group consisting of allowing a mixture obtained in the organic solvent mixing step to stand and stirring the mixture, in which
the emulsifying agent contains a lipophilic part and a hydrophilic part, and the hydrophilic part has a polyoxyethylene group.

<2> The method described in <1>, in which the hydrophilic part contains a phosphoric ester part.

<3> The method described in <1> or <2>, in which in the mixed state maintaining step, at least one selected from the group consisting of allowing the mixture to stand and stirring the mixture is performed until a viscosity of the mixture becomes constant.

<4> The method described in any one of <1> to <3>, in which in the mixed state maintaining step, the mixture is allowed to stand for not less than 30 minutes.

<5> The method described in any one of <1> to <4>, further including: a loose agglutinating step of causing the mixture after the mixed state maintaining step to come into contact with water so as to produce, in an aqueous phase, an agglutinate of the fine polymer particles (A) which agglutinate contains the organic solvent (B); and
a separating step of separating the agglutinate from the aqueous phase.

<6> The method described in <5>, further including a step of repeating a cycle selected from the following (i) and (ii) at least once after the separating step:
(i) A first cycle including a first step of adding the organic solvent (B) to the agglutinate obtained in the separating step, a second step of causing a mixture obtained in the first step to come into contact with water so as to produce, in an aqueous phase, an agglutinate of the fine polymer particles (A) which agglutinate contains the organic solvent (B), and a third step of separating, from the aqueous phase, the agglutinate obtained in the second step; and
(ii) a second cycle including a first step of adding water to the agglutinate obtained in the separating step, a second step of causing a mixture obtained in the first step to come into contact with the organic solvent (B) so as to produce, in an aqueous phase, an agglutinate of the fine polymer particles (A) which agglutinate contains the organic solvent (B), and a third step of separating, from the aqueous phase, the agglutinate obtained in the second step.

<7> A method for producing purified fine polymer particles (A), including: an organic solvent mixing step of mixing an organic solvent (B) and a latex that contains fine polymer particles (A) and an emulsifying agent;
a loose agglutinating step of causing a mixture obtained in the organic solvent mixing step to come into contact with water so as to produce, in an aqueous phase, an agglutinate of the fine polymer particles (A) which agglutinate contains the organic solvent (B); and
a separating step of separating the agglutinate from the aqueous phase, in which
the method further includes a step of repeating a cycle selected from (i) and (ii) blow at least once after the separating step.
(i) A first cycle including a first step of adding the organic solvent (B) to the agglutinate obtained in the separating step, a second step of causing a mixture obtained in the first step to come into contact with water so as to produce, in an aqueous phase, an agglutinate of the fine polymer particles (A) which agglutinate contains the organic solvent (B), and a third step of separating, from the aqueous phase, the agglutinate obtained in the second step; and
(ii) a second cycle including a first step of adding water to the agglutinate obtained in the separating step, a second step of causing a mixture obtained in the first step to come into contact with the organic solvent (B) so as to produce, in an aqueous phase, an agglutinate of the fine polymer particles (A) which agglutinate contains the organic solvent (B), and a third step of separating, from the aqueous phase, the agglutinate obtained in the second step.

<8> The method described in <7>, further including a mixed state maintaining step of performing at least one selected from the group consisting of allowing a mixture obtained in the organic solvent mixing step to stand and stirring the mixture.

<9> The method described in <8>, in which in the mixed state maintaining step, at least one selected from the group consisting of allowing the mixture to stand and stirring the mixture is performed until a viscosity of the mixture becomes constant.

<10> The method described in <8> or <9>, in which in the mixed state maintaining step, the mixture is allowed to stand for not less than 30 minutes.

<11> The method described in any one of <1> to <10>, in which the fine polymer particles (A) have a graft part that is constituted by a polymer which contains, as one or more structural units, one or more structural units derived from at least one type of monomer selected from the group consisting of aromatic vinyl monomers, vinyl cyanide monomers, and (meth)acrylate monomers.

<12> A method for producing a resin composition, including, as a step, the method described in any one of <5> to <10>, including:
a re-dispersing step of re-dispersing, in an organic solvent (C), the agglutinate that has been separated from the aqueous phase; and
a resin mixing step of mixing, with a resin (D), a dispersion solution obtained in the re-dispersing step.

<13> The method described in <12>, in which the resin (D) is a thermosetting resin.

### EXAMPLES

### Examples A

The following description will discuss one or more embodiments of the present invention on the basis of Examples A1 to A6 and Comparative Examples A1 to A4. Note that one or more embodiments of the present invention are not limited to these Examples A.

[Evaluation Methods]

First, the following description will discuss a method for evaluating the resin compositions produced in Examples A1 to A6 and Comparative Examples A1 to A4.

<Measurement of Element Content>

After the resin composition was dried at 120° C. for 60 minutes, the amounts of P and S contained in the resin composition were measured using an X-ray fluorescence analyzer JSX-1000S (manufactured by JEOL Ltd.). Each element content was presented as a concentration (ppm) with respect to the parts by weight of the resin composition.

<Measurement of Permeability of Aqueous Phase>

The permeability of the aqueous phase discharged in the separating step was measured using a spectrophotometer, U-3310 Spectrophotometer manufactured by HITACHI, Ltd.

### PRODUCTION EXAMPLES

<1. Formation of Elastic Body by Polymerization>

### Production Example 1-1: Preparation of Polybutadiene Rubber Latex (R-1)

Into a pressure-resistant polymerization apparatus were introduced 185 parts by weight of deionized water, 0.002 parts by weight of disodium ethylenediaminetetraacetate (EDTA), 0.001 parts by weight of ferrous sulfate heptahydrate, and 0.065 parts by weight of, as an emulsifying agent, sodium polyoxyethylene lauryl ether phosphate (hydrophobic group: C12/polyoxyethylene number: n=4). Sodium polyoxyethylene lauryl ether phosphate is a phosphorus-based emulsifying agent in which the hydrophilic part has a polyoxyethylene group and a phosphoric ester part. Next, while the materials thus introduced were stirred, gas in the pressure-resistant polymerization apparatus was replaced with nitrogen, so as to sufficiently remove oxygen from the inside of the pressure-resistant polymerization apparatus. After that, 100 parts by weight of butadiene (Bd) was introduced into the pressure-resistant polymerization apparatus, and the temperature inside the pressure-resistant polymerization apparatus was raised to 45° C. After that, 0.03 parts by weight of paramenthane hydroperoxide (PHP) was introduced into the pressure-resistant polymerization apparatus, and then 0.05 parts by weight of sodium formaldehyde sulfoxylate (SFS) was introduced into the pressure-resistant polymerization apparatus. Polymerization was then started. Polymerization was then started. At the time 20 hours had elapsed from the start of the polymerization, residual monomers not used in the polymerization were removed by devolatilization under reduced pressure, and thereby the polymerization was ended. During the polymerization, PHP and sodium polyoxyethylene lauryl ether phosphate were added to the pressure-resistant polymerization apparatus in discretionarily selected amounts and discretionarily selected points in time. By the polymerization, an aqueous latex (R-1), which contained an elastic body containing polybutadiene rubber as a main component, was obtained. The volume-average particle size of the elastic body contained in the obtained aqueous latex was 150 nm.

### Production Example 1-2: Preparation of Polybutadiene Rubber Latex (R-2)

Into a pressure-resistant polymerization apparatus were introduced 185 parts by weight of deionized water, 0.03 parts by weight of tripotassium phosphate, 0.002 parts by weight of EDTA, 0.001 parts by weight of ferrous sulfate heptahydrate, and 0.065 parts by weight of sodium dodecylbenzenesulfonate (SDBS) as an emulsifying agent. Polymerization was then started. In SDBS, the hydrophilic part does not have a polyoxyethylene group or a phosphoric ester part, and SDBS is a sulfur-based emulsifying agent having straight-chain alkyl benzene and a sulfate ester part. Next, while the materials thus introduced were stirred, gas in the pressure-resistant polymerization apparatus was replaced with nitrogen, so as to sufficiently remove oxygen from the inside of the pressure-resistant polymerization apparatus. After that, 100 parts by weight of Bd was introduced into the pressure-resistant polymerization apparatus, and the temperature inside the pressure-resistant polymerization apparatus was raised to 45° C. After that, 0.03 parts by weight of PHP was introduced into the pressure-resistant polymerization apparatus, and then 0.05 parts by weight of SFS was introduced into the pressure-resistant polymerization apparatus. Polymerization was then started. Polymerization was then started. At the time 20 hours had elapsed from the start of the polymerization, residual monomers not used in the polymerization were removed by devolatilization under reduced pressure, and thereby the polymerization was ended. During the polymerization, PHP and SDBS were each added to the pressure-resistant polymerization apparatus in discretionarily selected amounts and discretionarily selected points in time. By the polymerization, an aqueous latex (R-2), which contained an elastic body containing polybutadiene rubber as a main component, was obtained. The volume-average particle size of the elastic body contained in the obtained aqueous latex was 170 nm.

<2. Preparation of Fine Polymer Particles (A) (Formation of Graft Part by Polymerization)>

### Production Example 2-1; Preparation of Fine Polymer Particle Latex (L1)

Into a glass reaction vessel were introduced 250 parts by weight of the polybutadiene rubber latex (R-1) (including 87 parts by weight of the elastic body containing polybutadiene rubber as a main component) and 30 parts by weight of deionized water. The glass reaction vessel had a thermometer, a stirrer, a reflux condenser, a nitrogen inlet, and a monomer adding device. In Production Example 2-2 and subsequent Production Examples also, a glass reaction vessel identical to the glass reaction vessel used in Production Example 2-1 was used as a glass reaction vessel.

Gas in the glass reaction vessel was replaced with nitrogen, and the materials thus introduced were stirred at 60° C. Next, 0.004 parts by weight of EDTA, 0.001 parts by weight of ferrous sulfate heptahydrate, and 0.2 parts by weight of SFS were added to the glass reaction vessel, and a resulting mixture was stirred for 10 minutes. Thereafter, a mixture of 12.5 parts by weight of methyl methacrylate (MMA), 0.5 parts by weight of styrene (St), and 0.035 parts by weight of t-butyl hydroperoxide (BHP) was added continuously to the glass reaction vessel over 80 minutes. Then, 0.013 parts by weight of BHP was added to the glass reaction vessel, and the resultant mixture in the glass reaction vessel was stirred for another hour so as to finish polymerization. Through the operations above was obtained an aqueous latex (L1) that contains the fine polymer particles (A) and a phosphorus-based emulsifying agent (sodium polyoxyethylene lauryl ether phosphate) having a polyoxyethylene group. 99% or more of the monomer component had been polymerized. The volume-average particle size of the fine polymer particles (A) contained in the obtained aqueous latex was 160 nm. The solid content concentration (concentration of the fine polymer particles (A)) in 100% by weight of the obtained aqueous latex (L1) was 34% by weight. In addition, the amount of the phosphorus-based emulsifying agent having a polyoxyethylene group in 100% by weight of the obtained aqueous latex (L1) was 0.80% by weight.

### Production Example 2-2; Preparation of Fine Polymer Particle Latex (L2)

Into a glass reaction vessel were introduced 250 parts by weight of the polybutadiene rubber latex (R-2) (including 87 parts by weight of the elastic body containing polybutadiene rubber as a main component) and 30 parts by weight of deionized water. Gas in the glass reaction vessel was replaced with nitrogen, and the materials thus introduced were stirred at 60° C. Next, 0.004 parts by weight of EDTA, 0.001 parts by weight of ferrous sulfate heptahydrate, and 0.2 parts by weight of SFS were added to the glass reaction vessel, and a resulting mixture was stirred for 10 minutes. Next, a mixture of 12.5 parts by weight of MMA, 0.5 parts by weight of St, and 0.035 parts by weight of BHP was continuously added to the glass reaction vessel over 80 minutes. Then, 0.013 parts by weight of BHP was added to the glass reaction vessel, and the resultant mixture in the glass reaction vessel was stirred for another hour so as to finish polymerization. Through the operations above was obtained an aqueous latex (L2) that contains the fine polymer particles (A) and a sulfur-based emulsifying agent (SDBS) having no polyoxyethylene group. 99% or more of the monomer component had been polymerized. The volume-average particle size of the fine polymer particles (A) contained in the obtained aqueous latex was 181 nm. The solid content concentration (concentration of the fine polymer particles (A)) in the obtained aqueous latex (L2) was 34% by weight. In addition, the amount of the sulfur-based emulsifying agent in the obtained aqueous latex (L2) was 0.90% by weight.

### Production Example 2-3; Preparation of Fine Polymer Particle Latex (L3)

Into a glass reaction vessel were introduced 182 parts by weight of deionized water and 0.01 parts by weight of sodium polyoxyethylene lauryl ether phosphate (hydrophobic group: C12/polyoxyethylene number: n=4) as an emulsifying agent. Next, while the materials thus introduced were being stirred, gas in the glass reaction vessel was replaced with nitrogen, so as to sufficiently remove oxygen from the inside of the glass reaction vessel. Then, 8.5 parts by weight of MMA, 0.17 parts by weight of allyl methacrylate (AMA), and 0.003 parts by weight of cumene hydroperoxide (QHP) were introduced into the glass reaction vessel, and the temperature inside the glass reaction vessel was raised to 60° C. Next, 0.002 parts by weight of EDTA, 0.001 parts by weight of ferrous sulfate heptahydrate, and 0.2 parts by weight of SFS were introduced, and polymerization was started. Next, 78.5 parts by weight of MMA, 1.57 parts by weight of AMA, and 0.03 parts by weight of QHP were added continuously over 180 minutes. During the polymerization, QHP and sodium polyoxyethylene lauryl ether phosphate were each added to the glass reaction vessel in discretionarily selected amounts and discretionarily selected points in time.

The volume-average particle size of the elastic body contained in the aqueous latex obtained by the polymerization was 170 nm. Next, a mixture of 12.5 parts by weight of MMA, 0.5 parts by weight of St, and 0.035 parts by weight of BHP was continuously added to the glass reaction vessel over 80 minutes. Then, 0.013 parts by weight of BHP was added to the glass reaction vessel, and the resultant mixture in the glass reaction vessel was stirred for another hour so as to finish polymerization. Through the operations above was obtained an aqueous latex (L3) that contains the fine polymer particles (A) and a phosphorus-based emulsifying agent (sodium polyoxyethylene lauryl ether phosphate) having a polyoxyethylene group. 99% or more of the monomer component had been polymerized. The volume-average particle size of the fine polymer particles (A) contained in the obtained aqueous latex was 180 nm. The solid content concentration (concentration of the fine polymer particles (A)) in 100% by weight of the obtained aqueous latex (L3) was 32% by weight. In addition, the amount of the phosphorus-based emulsifying agent having a polyoxyethylene group in 100% by weight of the obtained aqueous latex (L3) was 0.70% by weight.

### Production Example 2-4; Preparation of Fine Polymer Particle Latex (L4)

Into a glass reaction vessel were introduced 182 parts by weight of deionized water and 0.01 parts by weight of sodium polyoxyethylene lauryl ether phosphate (hydrophobic group: C13 branched/polyoxyethylene number: n=6) as an emulsifying agent. Next, while the materials thus introduced were being stirred, gas in the glass reaction vessel was replaced with nitrogen, so as to sufficiently remove oxygen from the inside of the glass reaction vessel. Then, 8.5 parts by weight of MMA, 0.17 parts by weight of AMA, and 0.003 parts by weight of QHP were introduced into the glass reaction vessel, and the temperature inside the glass reaction vessel was raised to 60° C. Next, 0.002 parts by weight of EDTA, 0.001 parts by weight of ferrous sulfate heptahydrate, and 0.2 parts by weight of SFS were introduced, and polymerization was started. Next, 78.5 parts by weight of MMA, 1.57 parts by weight of AMA, and 0.03 parts by weight of QHP were added continuously over 180 minutes. During the polymerization, QHP and sodium polyoxyethylene lauryl ether phosphate were each added to the glass reaction vessel in discretionarily selected amounts and discretionarily selected points in time. The volume-average particle size of the elastic body contained in the aqueous latex obtained by the polymerization was 170 nm. Next, a mixture of 12.5 parts by weight of MMA, 0.5 parts by weight of St, and 0.035 parts by weight of BHP was continuously added to the glass reaction vessel over 80 minutes. Then, 0.013 parts by weight of BHP was added to the glass reaction vessel, and the resultant mixture in the glass reaction vessel was stirred for another hour so as to finish polymerization. Through the operations above was obtained an aqueous latex (L4) that contains the fine polymer particles (A) and a phosphorus-based emulsifying agent (sodium polyoxyethylene lauryl ether phosphate) having a polyoxyethylene group. 99% or more of the monomer component had been polymerized. The volume-average particle size of the fine polymer particles (A) contained in the obtained aqueous latex was 180 nm. The solid content concentration (concentration of the fine polymer particles (A)) in 100% by weight of the obtained aqueous latex (L4) was 32% by weight. In addition, the amount of the phosphorus-based emulsifying agent having a polyoxyethylene group in 100% by weight of the obtained aqueous latex (L4) was 0.70% by weight.

### Production Example 2-5; Preparation of Fine Polymer Particle Latex (L5)

Into a glass reaction vessel were introduced 182 parts by weight of deionized water and 0.01 parts by weight of sodium polyoxyethylene lauryl ether phosphate (hydrophobic group: C13 branched/polyoxyethylene number: n=10) as an emulsifying agent. Next, while the materials thus introduced were being stirred, gas in the glass reaction vessel was replaced with nitrogen, so as to sufficiently remove oxygen from the inside of the glass reaction vessel. Then, 8.5 parts by weight of MMA, 0.17 parts by weight of AMA, and 0.003 parts by weight of QHP were introduced, and the temperature inside the glass reaction vessel was raised to 60° C. Next, 0.002 parts by weight of EDTA, 0.001 parts by weight of ferrous sulfate heptahydrate, and 0.2 parts by weight of SFS were introduced, and polymerization was started. Next, 78.5 parts by weight of MMA, 1.57 parts by weight of AMA, and 0.03 parts by weight of QHP were added continuously over 180 minutes. During the polymerization, QHP and sodium polyoxyethylene lauryl ether phosphate were each added to the glass reaction vessel in discretionarily selected amounts and discretionarily selected points in time. The volume-average particle size of the elastic body contained in the aqueous latex obtained by the polymerization was 170 nm. Next, a mixture of 12.5 parts by weight of MMA, 0.5 parts by weight of St, and 0.035 parts by weight of BHP was continuously added to the glass reaction vessel over 80 minutes. Then, 0.013 parts by weight of BHP was added to the glass reaction vessel, and the resultant mixture in the glass reaction vessel was stirred for another hour so as to finish polymerization. Through the operations above was obtained an aqueous latex (L5) that contains the fine polymer particles (A) and a phosphorus-based emulsifying agent (sodium polyoxyethylene lauryl ether phosphate) having a polyoxyethylene group. 99% or more of the monomer component had been polymerized. The volume-average particle size of the fine polymer particles (A) contained in the obtained aqueous latex was 180 nm. The solid content concentration (concentration of the fine polymer particles (A)) in 100% by weight of the obtained aqueous latex (L5) was 32% by weight. In addition, the amount of the phosphorus-based emulsifying agent having a polyoxyethylene group in 100% by weight of the obtained aqueous latex (L5) was 0.70% by weight.

### Production Example 2-6; Preparation of Fine Polymer Particle Latex (L6)

Into a glass reaction vessel were introduced 182 parts by weight of deionized water and 0.01 parts by weight of sodium polyoxyethylene alkyl ether sulfate (sulfur-based emulsifying agent containing a polyoxyethylene group) as an emulsifying agent. Next, while the materials thus introduced were being stirred, gas in the glass reaction vessel was replaced with nitrogen, so as to sufficiently remove oxygen from the inside of the glass reaction vessel. Then, 8.5 parts by weight of MMA, 0.17 parts by weight of AMA, and 0.003 parts by weight of QHP were introduced, and the temperature inside the glass reaction vessel was raised to 60° C. Next, 0.002 parts by weight of EDTA, 0.001 parts by weight of ferrous sulfate heptahydrate, and 0.2 parts by weight of SFS were introduced, and polymerization was started. Next, 78.5 parts by weight of MMA, 1.57 parts by weight of AMA, and 0.03 parts by weight of QHP were added continuously over 180 minutes. During the polymerization, QHP and sodium polyoxyethylene lauryl ether phosphate were each added to the glass reaction vessel in discretionarily selected amounts and discretionarily selected points in time. The volume-average particle size of the elastic body contained in the aqueous latex obtained by the polymerization was 170 nm. Next, a mixture of 12.5 parts by weight of MMA, 0.5 parts by weight of St, and 0.035 parts by weight of BHP was continuously added to the glass reaction vessel over 80 minutes. Then, 0.013 parts by weight of BHP was added to the glass reaction vessel, and the resultant mixture in the glass reaction vessel was stirred for another hour so as to finish polymerization. Through the operations above was obtained an aqueous latex (L6) that contains the fine polymer particles (A) and a sulfur-based emulsifying agent (sodium polyoxyethylene alkyl ether sulfate) having a polyoxyethylene group. 99% or more of the monomer component had been polymerized. The volume-average particle size of the fine polymer particles (A) contained in the obtained aqueous latex was 180 nm. The solid content concentration (concentration of the fine polymer particles (A)) in 100% by weight of the obtained aqueous latex (L6) was 32% by weight. In addition, the amount of the sulfur-based emulsifying agent having a polyoxyethylene group in 100% by weight of the obtained aqueous latex (L6) was 0.70% by weight.

### Example A1

756 g of methyl ethyl ketone (MEK) (solubility in water at 20° C., 10% by weight) was introduced as an organic solvent (B) into 4-L vessel with a stirrer (the inner diameter of the vessel was 100 mm, and, in the stirrer, four flat paddle blades having a blade diameter of 75 mm were provided axially in three stages). Next, while the raw material (MEK) in the vessel was being stirred at 450 rpm, 1000 g of the latex (L1) containing the fine polymer particles (A) obtained in Production Example 2-1 was introduced in the vessel, and stirring was performed for 5 seconds (organic solvent mixing step). The mixture (latex (L1) and MEK) in the vessel was stirred at 450 rpm for another 60 minutes (mixed state maintaining step). The FIGURE clearly indicates that the viscosity of the mixture is constant by stirring the above mixture at 300 rpm for 60 minutes. In Example A1, the above mixture was stirred at 450 rpm for 60 minutes, and it can therefore be said that the viscosity of the mixture is constant. That is, in the mixed state maintaining step in Example A1, the mixture was stirred until the viscosity of the mixture became constant.

After the mixed state maintaining step, while the mixture (latex (L1) and MEK) in the vessel was being stirred at 500 rpm, 800 g of purified water was added continuously to the vessel at a feed rate of 200 g/min. After the supply of the purified water ended, stirring of the mixture was promptly stopped. By this operation, a slurry which was constituted by a buoyant agglutinate and an aqueous phase partially containing an organic solvent was obtained (loose agglutinating step). Next, 1200 g of the aqueous phase was discharged from the outlet at the lower part of the vessel such that the agglutinate containing part of the aqueous phase remained in the vessel, so that an agglutinate which was purified fine polymer particles (A) and which contained part of the aqueous phases was obtained (separating step). The permeability of the discharged aqueous phase was measured, and it was found that the permeability of the aqueous phase was 21%, and no white turbidity of the aqueous phase was observed.

660 g of MEK was added as the organic solvent (C) to the agglutinate of the purified fine polymer particles (A) obtained in the separating step. The obtained mixture was mixed under a stirring condition of 500 rpm for 30 minutes, so that a dispersion solution in which the fine polymer particles (A) were uniformly dispersed in MEK was obtained (re-dispersing step). The dispersion solution was introduced into 1-L vessel equipped with a jacket and a stirrer (the inner diameter of the vessel was 100 mm, and, in the stirrer, a 90 mm anchor blade was provided), and 567 g of an epoxy resin (product name: JER828; manufactured by Mitsubishi Chemical Corporation) was added as a resin (D) to the vessel. The resultant mixture was mixed until the mixture became uniform (resin mixing step). Subsequently, the jacket temperature (temperature of warm water in the vessel) was set to 60° C., and a vacuum pump (oil-sealed rotary vacuum pump; TSW-150, manufactured by SATO VAC INC.) was used to distill off the volatile components under reduced pressure until the volatile component concentration in the mixture reached a predetermined concentration (5000 rpm) (distilling step). By this operation, a resin composition containing the fine polymer particles (A) and the epoxy resin was obtained.

The amounts of the elements (phosphorus (P) and sulfur (S)) in the resultant resin composition were measured. Table 1 shows the results.

### Example A2

The organic solvent mixing step, the mixed state maintaining step, the loose agglutinating step, and the separating step were carried out as in Example A1. After the separating step, the rinsing step (first to third steps in the second cycle) was carried out. Specifically, while the mixture in the vessel (an agglutinate of the purified fine polymer particles (A) containing part of the aqueous phase) was being stirred at 500 rpm, 450 g of purified water was added continuously to the vessel at a supply rate of 200 g/min (first step in the second cycle). Subsequently, 120 g of MEK was added to the vessel. Then, the mixture in the vessel was stirred at 450 rpm for 5 minutes. By this operation, a slurry which was constituted by a buoyant agglutinate and an aqueous phase partially containing an organic solvent was obtained (second step in the second cycle). Next, 1000 g of the aqueous phase was discharged from the outlet at the lower part of the vessel such that the agglutinate containing part of the aqueous phase remained in the vessel, so that an agglutinate which was purified fine polymer particles (A) and which contained part of the aqueous phases was obtained (third step in the second cycle). The permeability of the discharged aqueous phase was measured, and it was found that the permeability of the aqueous phase was 33%, and no white turbidity of the aqueous phase was observed.

With use of the agglutinate of the purified fine polymer particles (A) obtained in the third step in the second cycle, the re-dispersing step, the resin mixing step, and the distilling step were carried out as in Example A1, so that a resin composition containing fine polymer particles (A) and an epoxy resin was obtained. That is, in Example A2, the second cycle was performed once as the rinsing step.

The amounts of the elements (phosphorus (P) and sulfur (S)) in the resultant resin composition were measured. Table 1 shows the results.

### Example A3

1000 g of methyl ethyl ketone (MEK) (solubility in water at 20° C., 10% by weight) was introduced as an organic solvent (B) into 4-L vessel with a stirrer (the inner diameter of the vessel was 100 mm, and, in the stirrer, four flat paddle blades having a blade diameter of 75 mm were provided axially in three stages). Next, while the raw material (MEK) in the vessel was being stirred at 450 rpm, 1000 g of the latex (L3) containing the fine polymer particles (A) obtained in Production Example 2-3 was introduced in the vessel, and stirring was performed for 5 seconds (organic solvent mixing step). Then, the mixture in the vessel (latex (L3) and MEK) was stirred at 450 rpm for another 60 minutes, and the mixture was stirred until the viscosity of the mixture became constant (mixed state maintaining step).

After the mixed state maintaining step, while the mixture (latex (L3) and MEK) in the vessel was being stirred at 500 rpm, 500 g of purified water was added continuously to the vessel at a feed rate of 200 g/min. After the supply of the purified water ended, stirring of the mixture was promptly stopped. By this operation, a slurry which was constituted by a buoyant agglutinate and an aqueous phase partially containing an organic solvent was obtained (loose agglutinating step (first stage)). Next, 1320 g of the aqueous phase was discharged from the outlet at the lower part of the vessel such that the agglutinate containing part of the aqueous phase remained in the vessel, so that an agglutinate which was purified fine polymer particles (A) and which contained part of the aqueous phases was obtained (separating step). The permeability of the discharged aqueous phase was measured, and it was found that the permeability of the aqueous phase was 27%, and no white turbidity of the aqueous phase was observed.

600 g of MEK was added as the organic solvent (C) to the agglutinate of the purified fine polymer particles (A) obtained in the separating step. The obtained mixture was mixed under a stirring condition of 500 rpm for 30 minutes, so that a dispersion solution in which the fine polymer particles (A) were uniformly dispersed in MEK was obtained (re-dispersing step). The dispersion solution was introduced into 1-L vessel equipped with a jacket and a stirrer (the inner diameter of the vessel was 100 mm, and, in the stirrer, a 90 mm anchor blade was provided), and 1813 g of an epoxy resin (product name: JER828; manufactured by Mitsubishi Chemical Corporation) was added as a resin (D) to the vessel. The resultant mixture was mixed until the mixture became uniform (resin mixing step). Subsequently, the jacket temperature (temperature of warm water in the vessel) was set to 60° C., and a vacuum pump (oil-sealed rotary vacuum pump; TSW-150, manufactured by SATO VAC INC.) was used to distill off the volatile components under reduced pressure until the volatile component concentration in the mixture reached a predetermined concentration (5000 rpm) (distilling step). By this operation, a resin composition containing the fine polymer particles (A) and the epoxy resin was obtained. The amounts of the elements (phosphorus (P) and sulfur (S)) in the resultant resin composition were measured. Table 1 shows the results.

### Example A4

The organic solvent mixing step, the mixed state maintaining step, the loose agglutinating step, and the separating step were carried out as in Example A3 except that the latex (L4) obtained in Production Example 2-4 was used instead of the latex (L3), so that an agglutinate which was purified fine polymer particles (A) and which contained part of the aqueous phase was obtained. The permeability of the aqueous phase discharged in the separating step of Example A4 was measured, and it was found that the permeability of the aqueous phase was 62%, and no white turbidity of the aqueous phase was observed.

With use of the agglutinate of the purified fine polymer particles (A) obtained in the separating step, the re-dispersing step, the resin mixing step, and the distilling step were carried out as in Example A3, so that a resin composition containing fine polymer particles (A) and an epoxy resin was obtained. The amounts of the elements (phosphorus (P) and sulfur (S)) in the resultant resin composition were measured. Table 1 shows the results.

### Example A5

The organic solvent mixing step, the mixed state maintaining step, the loose agglutinating step, and the separating step were carried out as in Example A3 except that the latex (L5) obtained in Production Example 2-5 was used instead of the latex (L3), so that an agglutinate which was purified fine polymer particles (A) and which contained part of the aqueous phase was obtained. The permeability of the aqueous phase discharged in the separating step of Example A5 was measured, and it was found that the permeability of the aqueous phase was 22%, and no white turbidity of the aqueous phase was observed.

With use of the agglutinate of the purified fine polymer particles (A) obtained in the separating step, the re-dispersing step, the resin mixing step, and the distilling step were carried out as in Example A3, so that a resin composition containing fine polymer particles (A) and an epoxy resin was obtained. The amounts of the elements (phosphorus (P) and sulfur (S)) in the resultant resin composition were measured. Table 1 shows the results.

### Example A6

The organic solvent mixing step, the mixed state maintaining step, the loose agglutinating step, and the separating step were carried out as in Example A3 except that the latex (L6) obtained in Production Example 2-6 was used instead of the latex (L3), so that an agglutinate which was purified fine polymer particles (A) and which contained part of the aqueous phase was obtained. The permeability of the aqueous phase discharged in the separating step of Example A6 was measured, and it was found that the permeability of the aqueous phase was 44%, and no white turbidity of the aqueous phase was observed.

With use of the agglutinate of the purified fine polymer particles (A) obtained in the separating step, the re-dispersing step, the resin mixing step, and the distilling step were carried out as in Example A3, so that a resin composition containing fine polymer particles (A) and an epoxy resin was obtained. The amounts of the elements (phosphorus (P) and sulfur (S)) in the resultant resin composition were measured. Table 1 shows the results.

### Comparative Example A1

The organic solvent mixing step, the loose agglutinating step, and the separating step were carried out as in Example A1 except that, after the organic solvent mixing step, the mixed state maintaining step was not carried out but the loose agglutinating step was promptly carried out, so that an agglutinate containing part of the aqueous phase was obtained. The permeability of the aqueous phase discharged in the separating step in Comparative Example A1 was measured, and it was found that the permeability of the aqueous phase was 0.05% and white turbidity was observed.

### Comparative Example A2

The organic solvent mixing step, the loose agglutinating step, and the separating step were carried out as in Example A3 except that, after the organic solvent mixing step, the mixed state maintaining step was not carried out but the loose agglutinating step was promptly carried out, so that an agglutinate containing part of the aqueous phase was obtained. The permeability of the aqueous phase discharged in the separating step in Comparative Example A2 was measured, and it was found that the permeability of the aqueous phase was 0.11% and white turbidity was observed.

### Comparative Example A3

The organic solvent mixing step, the loose agglutinating step, and the separating step were carried out as in Example A4 except that, after the organic solvent mixing step, the mixed state maintaining step was not carried out but the loose agglutinating step was promptly carried out, so that an agglutinate containing part of the aqueous phase was obtained. The permeability of the aqueous phase discharged in the separating step in Comparative Example A3 was measured, and it was found that the permeability of the aqueous phase was 0.12% and white turbidity was observed.

### Comparative Example A4

The organic solvent mixing step, the loose agglutinating step, and the separating step were carried out as in Example A5 except that, after the organic solvent mixing step, the mixed state maintaining step was not carried out but the loose agglutinating step was promptly carried out, so that an agglutinate containing part of the aqueous phase was obtained. The permeability of the aqueous phase discharged in the separating step in Comparative Example A4 was measured, and it was found that the permeability of the aqueous phase was 0.02% and white turbidity was observed.

[Measurement of Viscosity of Mixture]

The organic solvent mixing step was carried out under conditions identical to those in Example A1. That is, the latex containing a phosphorus-based emulsifying agent having a polyoxyethylene group was mixed with MEK (organic solvent) so that a mixture was obtained. The obtained mixture (latex (L1) and MEK) (indicated as “mixture containing phosphorus-based emulsifying agent” in the FIGURE) was stirred at 300 rpm. The viscosity of the mixture was measured using a viscometer (digital viscometer DV-II+Pro manufactured by BROOKFIELD) at 5 seconds, 5 minutes, 15 minutes, 30 minutes, 45 minutes, 60 minutes, and 90 minutes after the stirring of the mixture was started. The results are indicated with black triangles in the FIGURE.

The organic solvent mixing step was carried out under conditions identical to those in Example A1. That is, the latex containing a sulfur-based emulsifying agent having no polyoxyethylene group was mixed with MEK (organic solvent) so that a mixture was obtained. The obtained mixture (latex (L2) and MEK) (indicated as “mixture containing sulfur-based emulsifying agent” in the FIGURE) was stirred at 300 rpm. The viscosity of the mixture was measured using a viscometer (digital viscometer DV-II+Pro manufactured by BROOKFIELD) at 5 seconds, 5 minutes, 15 minutes, and 30 minutes after the stirring of the mixture was started. The results are indicated with black circles in the FIGURE.

The viscosity of the mixture was measured while changing the spindle as necessary according to the viscosity range and using CPE-52 according to the viscosity range and while changing a shear rate as necessary at a temperature of 25° C.

The FIGURE is a graph that shows changes over time in the viscosity of a mixture of an organic solvent and a latex which contains a phosphorus-based emulsifying agent having a polyoxyethylene group or a sulfur-based emulsifying agent having no polyoxyethylene group. In the FIGURE, the viscosity of the mixture (latex (L1) and MEK) was sharply increased until 20 minutes after the start of the mixing, was constant 30 minutes after the start, and was no longer changing 60 minutes after the start. Meanwhile, the viscosity of the mixture (latex (L2) and MEK) was constant from immediately after the start of the mixing until the end of the mixing, and was not changed.

The mixture obtained after the organic solvent mixing step in each of Examples A2 to A6 was also stirred at 300 rpm, and the viscosity of the mixture was measured using a viscometer (digital viscometer DV-II+Pro manufactured by BROOKFIELD) at 5 seconds, 5 minutes, 15 minutes, 30 minutes, 45 minutes, 60 minutes, and 90 minutes after the stirring of the mixture was started. As a result, the viscosity of each mixture became constant approximately 30 minutes after the start, was no longer changing 60 minutes after the start. Therefore, it can be said that, in Examples A2 to A6 also, as the operation in the mixed state maintaining step, stirring was performed until the viscosity of the mixture obtained in the organic solvent mixing step became constant.

TABLE 1

| | | | | Permeability of | | | |
|---|---|---|---|---|---|---|---|
| | | | | discharged aqueous phase | | | |
| | Mixed state | | | After | After | | |
| | maintaining | | | separating | rinsing | Amount of impurities | |
| | step | Rinsing step | Latex | step [%] | step [%] | P [ppm] | S [ppm] |
| Example A1 | Performed | Not performed | L1 | 21 | — | 93 | 104 |
| Example A2 | Performed | Performed | L1 | 21 | 33 | 42 | 45 |
| Example A3 | Performed | Not performed | L3 | 27 | — | 49 | 45 |
| Example A4 | Performed | Not performed | L4 | 62 | — | N.D. | 47 |
| Example A5 | Performed | Not performed | L5 | 22 | — | N.D. | 44 |
| Example A6 | Performed | Not performed | L6 | 44 | — | N.D. | N.D. |
| Comparative | Not | Not performed | L1 | 0.05 | — | — | — |
| Example A1 | performed | | | | | | |
| Comparative | Not | Not performed | L3 | 0.11 | — | — | — |
| Example A2 | performed | | | | | | |
| Comparative | Not | Not performed | L4 | 0.12 | — | — | — |
| Example A3 | performed | | | | | | |
| Comparative | Not | Not performed | L5 | 0.02 | — | — | — |
| Example A4 | performed | | | | | | |

The aqueous phase discharged in the separating step in Examples A1 to A6 and the aqueous phase discharged in the rinsing step in Example A2 hardly contained fine polymer particles (A) and had sufficient permeability. The resin compositions obtained in Examples A1 to A6 contained extremely small amounts of emulsifying agent-derived elements (P and S). Meanwhile, the aqueous phases discharged in the separating step in Comparative Examples A1 to A4 were white and turbid and contained a large amount of the fine polymer particles (A).

### Examples B

The following description will discuss one or more embodiments of the present invention on the basis of Examples B1 to B3 and Comparative Examples B1 and B2. Note that one or more embodiments of the present invention are not limited to these Examples B. The evaluations in Examples B1 to B3 and Comparative Examples B1 and B2 were performed in the manner described in the above section [Example A].

### Example B1

756 g of methyl ethyl ketone (MEK) (solubility in water at 20° C., 10% by weight) was introduced as an organic solvent (B) into 4-L vessel with a stirrer (the inner diameter of the vessel was 100 mm, and, in the stirrer, four flat paddle blades having a blade diameter of 75 mm were provided axially in three stages). Next, while the raw material (MEK) in the vessel was being stirred at 450 rpm, 1000 g of the latex (L1) containing the fine polymer particles (A) obtained in Production Example 2-1 was introduced in the vessel, and stirring was performed for 5 seconds (organic solvent mixing step). The mixture (latex (L1) and MEK) in the vessel was stirred at 450 rpm for another 60 minutes (mixed state maintaining step). The FIGURE clearly indicates that the viscosity of the mixture is constant by stirring the above mixture at 300 rpm for 60 minutes. In Example B1, the above mixture was stirred at 450 rpm for 60 minutes, and it can therefore be said that the viscosity of the mixture is constant. That is, in the mixed state maintaining step in Example B1, the mixture was stirred until the viscosity of the mixture became constant.

After the mixed state maintaining step, while the mixture (latex (L1) and MEK) in the vessel was being stirred at 500 rpm, 800 g of purified water was added continuously to the vessel at a feed rate of 200 g/min. After the supply of the purified water ended, stirring of the mixture was promptly stopped. By this operation, a slurry which was constituted by a buoyant agglutinate and an aqueous phase partially containing an organic solvent was obtained (loose agglutinating step). Next, 1200 g of the aqueous phase was discharged from the outlet at the lower part of the vessel such that the agglutinate containing part of the aqueous phase remained in the vessel, so that an agglutinate which was purified fine polymer particles (A) and which contained part of the aqueous phases was obtained (separating step). The permeability of the discharged aqueous phase was measured, and it was found that the permeability of the aqueous phase was 21%, and no white turbidity of the aqueous phase was observed.

After the separating step, the rinsing step (first to third steps in the second cycle) was carried out. Specifically, while the mixture in the vessel (an agglutinate of the purified fine polymer particles (A) containing part of the aqueous phase) after the separating step was being stirred at 500 rpm, 450 g of purified water was added continuously to the vessel at a supply rate of 200 g/min (first step in the second cycle). Subsequently, 120 g of MEK was added to the vessel. Then, the mixture in the vessel was stirred at 450 rpm for 5 minutes. By this operation, a slurry which was constituted by a buoyant agglutinate and an aqueous phase partially containing an organic solvent was obtained (second step in the second cycle). Next, 1000 g of the aqueous phase was discharged from the outlet at the lower part of the vessel such that the agglutinate containing part of the aqueous phase remained in the vessel, so that an agglutinate which was purified fine polymer particles (A) and which contained part of the aqueous phases was obtained (third step in the second cycle). The permeability of the discharged aqueous phase was measured, and it was found that the permeability of the aqueous phase was 33%, and no white turbidity of the aqueous phase was observed.

660 g of MEK was added as the organic solvent (C) to the agglutinate of the purified fine polymer particles (A) obtained in the third step in the second cycle. The obtained mixture was mixed under a stirring condition of 500 rpm for 30 minutes, so that a dispersion solution in which the fine polymer particles (A) were uniformly dispersed in MEK was obtained (re-dispersing step). The dispersion solution was introduced into 1-L vessel equipped with a jacket and a stirrer (the inner diameter of the vessel was 100 mm, and, in the stirrer, a 90 mm anchor blade was provided), and 567 g of an epoxy resin (product name: JER828; manufactured by Mitsubishi Chemical Corporation) was added as a resin (D) to the vessel. The resultant mixture was mixed until the mixture became uniform (resin mixing step). Subsequently, the jacket temperature (temperature of warm water in the vessel) was set to 60° C., and a vacuum pump (oil-sealed rotary vacuum pump; TSW-150, manufactured by SATO VAC INC.) was used to distill off the volatile components under reduced pressure until the volatile component concentration in the mixture reached a predetermined concentration (5000 rpm) (distilling step). By this operation, a resin composition containing the fine polymer particles (A) and the epoxy resin was obtained.

The amounts of the elements (phosphorus (P) and sulfur (S)) in the resultant resin composition were measured. Table 2 shows the results.

### Example B2

The organic solvent mixing step, the mixed state maintaining step, the loose agglutinating step, the separating step, and the rinsing step (first to third steps in the second cycle) were carried out as in Example B1 except that the latex (L2) obtained in Production Example 2-2 was used instead of the latex (L1), so that an agglutinate which was purified fine polymer particles (A) and which contained part of the aqueous phase was obtained. The permeability of the aqueous phase discharged in the third step in the second cycle of Example B2 was measured, and it was found that the permeability of the aqueous phase was 53%, and no white turbidity of the aqueous phase was observed.

Next, with use of the agglutinate of the purified fine polymer particles (A) obtained in the third step in the second cycle, the re-dispersing step, the resin mixing step, and the distilling step were carried out as in Example B1, so that a resin composition containing fine polymer particles (A) and an epoxy resin was obtained. The amounts of the elements (phosphorus (P) and sulfur (S)) in the resultant resin composition were measured. Table 2 shows the results.

### Example B3

The organic solvent mixing step, the mixed state maintaining step, the loose agglutinating step, and the separating step were carried out as in Example B1 except that the latex (L2) obtained in Production Example 2-2 was used instead of the latex (L1). Next, after the separating step, the first to third steps in the first cycle were carried out as the rinsing step. Specifically, while the mixture in the vessel (an agglutinate containing part of the aqueous phase) after the separating step was being stirred at 500 rpm, 120 g of MEK was added continuously to the vessel at a supply rate of 200 g/min (first step in the first cycle). Subsequently, 450 g of purified water was added to the vessel at a feed rate of 200 g/min. Then, the mixture in the vessel was stirred at 450 rpm for 5 minutes. By this operation, a slurry which was constituted by a buoyant agglutinate and an aqueous phase partially containing an organic solvent was obtained (second step in the first cycle). Next, 1000 g of the aqueous phase was discharged from the outlet at the lower part of the vessel such that the agglutinate containing part of the aqueous phase remained in the vessel, so that an agglutinate which was purified fine polymer particles (A) and which contained part of the aqueous phases was obtained (third step in the first cycle). The permeability of the discharged aqueous phase was measured, and it was found that the permeability of the aqueous phase was 54%, and no white turbidity of the aqueous phase was observed.

Next, with use of the agglutinate of the purified fine polymer particles (A) obtained in the third step in the first cycle, the re-dispersing step, the resin mixing step, and the distilling step were carried out as in Example B1, so that a resin composition containing fine polymer particles (A) and an epoxy resin was obtained. The amounts of the elements (phosphorus (P) and sulfur (S)) in the resultant resin composition were measured. Table 2 shows the results.

### Comparative Example B1

The organic solvent mixing step, the mixed state maintaining step, the loose agglutinating step, the separating step, the re-dispersing step, the resin mixing step, and the distilling step were carried out as in Example B1 except that the rinsing step was not carried out after the separating step and that the agglutinate obtained in the separating step was used for the subsequent re-dispersing step, so a resin composition containing fine polymer particles (A) and an epoxy resin was obtained. The amounts of the elements (phosphorus (P) and sulfur (S)) in the resultant resin composition were measured. Table 2 shows the results.

### Comparative Example B2

The organic solvent mixing step, the mixed state maintaining step, the loose agglutinating step, the separating step, the re-dispersing step, the resin mixing step, and the distilling step were carried out as in Example B2 except that the rinsing step was not carried out after the separating step and that the agglutinate obtained in the separating step was used for the subsequent re-dispersing step, so a resin composition containing fine polymer particles (A) and an epoxy resin was obtained. The amounts of the elements (phosphorus (P) and sulfur (S)) in the resultant resin composition were measured. Table 2 shows the results.

TABLE 2

| | | | | Permeability of | | | |
|---|---|---|---|---|---|---|---|
| | | | | discharged aqueous phase | | | |
| | Mixed state | | | After | After | | |
| | maintaining | | | separating | rinsing | Amount of impurities | |
| | step | Rinsing step | Latex | step [%] | step [%] | P [ppm] | S [ppm] |
| Example B1 | Performed | Performed | L1 | 21 | 33 | 42 | 45 |
| Example B2 | Performed | Performed | L2 | 59 | 53 | N.D. | 33 |
| Example B3 | Performed | Performed | L2 | 59 | 54 | N.D. | 43 |
| Comparative | Performed | Not | L1 | 21 | — | 93 | 104 |
| Example B1 | | performed | | | | | |
| Comparative | Performed | Not | L2 | 59 | — | N.D. | 141 |
| Example B2 | | performed | | | | | |

The resin compositions obtained in Examples B1 to B3 exhibited extremely small respective amounts and the total amounts of emulsifying agent-derived elements (P and S) in comparison with the resin compositions obtained in Comparative Examples B1 and B2.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method for producing purified fine polymer particles (A), comprising:
an organic solvent mixing step of mixing an organic solvent (B) and a latex containing fine polymer particles (A) and an emulsifying agent to obtain a mixture; and
a mixed state maintaining step of performing at least one selected from the group consisting of allowing the mixture to stand and stirring the mixture,
wherein the emulsifying agent contains a lipophilic part and a hydrophilic part, and the hydrophilic part has a polyoxyethylene group.

2. The method according to claim 1, wherein the hydrophilic part contains a phosphoric ester part.

3. The method according to claim 1, wherein, in the mixed state maintaining step, at least one selected from the group consisting of allowing the mixture to stand and stirring the mixture is performed until a viscosity of the mixture becomes constant.

4. The method according to claim 1, wherein, in the mixed state maintaining step, the mixture is allowed to stand for not less than 30 minutes.

5. The method according to claim 1, further comprising:
a loose agglutinating step of contacting the mixture after the mixed state maintaining step with water to produce, in an aqueous phase, an agglutinate of the fine polymer particles (A), wherein the agglutinate contains the organic solvent (B); and
a separating step of separating the agglutinate from the aqueous phase.

6. The method according to claim 5, further comprising a step of repeating, after the separating step, a cycle selected from the following (i) and (ii) at least once:
(i) a first cycle including:
a first step of adding the organic solvent (B) to the agglutinate obtained in the separating step,
a second step of contacting a mixture obtained in the first step with water to produce, in an aqueous phase, an agglutinate of the fine polymer particles (A) wherein the agglutinate contains the organic solvent (B), and
a third step of separating, from the aqueous phase, the agglutinate obtained in the second step; and
(ii) a second cycle including:
a first step of adding water to the agglutinate obtained in the separating step,
a second step of contacting a mixture obtained in the first step with the organic solvent (B) to produce, in an aqueous phase, an agglutinate of the fine polymer particles (A) wherein the agglutinate contains the organic solvent (B), and
a third step of separating, from the aqueous phase, the agglutinate obtained in the second step.

7. A method for producing purified fine polymer particles (A), comprising:
an organic solvent mixing step of mixing an organic solvent (B) and a latex containing fine polymer particles (A) and an emulsifying agent to obtain a mixture;
a loose agglutinating step of contacting the mixture obtained in the organic solvent mixing step with water to produce, in an aqueous phase, an agglutinate of the fine polymer particles (A) wherein the agglutinate contains the organic solvent (B); and
a separating step of separating the agglutinate from the aqueous phase, wherein
the method further comprises a step of repeating, after the separating step, a cycle selected from the following (i) and (ii) at least once:
(i) a first cycle including:
a first step of adding the organic solvent (B) to the agglutinate obtained in the separating step,
a second step of contacting a mixture obtained in the first step with water to produce, in an aqueous phase, an agglutinate of the fine polymer particles (A) wherein the agglutinate contains the organic solvent (B), and
a third step of separating, from the aqueous phase, the agglutinate obtained in the second step; and
(ii) a second cycle including:
a first step of adding water to the agglutinate obtained in the separating step,
a second step of contacting a mixture obtained in the first step with the organic solvent (B) to produce, in an aqueous phase, an agglutinate of the fine polymer particles (A) wherein the agglutinate contains the organic solvent (B), and
a third step of separating, from the aqueous phase, the agglutinate obtained in the second step.

8. The method according to claim 7, further comprising a mixed state maintaining step of performing at least one selected from the group consisting of allowing the mixture to stand and stirring the mixture.

9. The method according to claim 8, wherein in the mixed state maintaining step, at least one selected from the group consisting of allowing the mixture to stand and stirring the mixture is performed until a viscosity of the mixture becomes constant.

10. The method according to claim 8, wherein in the mixed state maintaining step, the mixture is allowed to stand for not less than 30 minutes.

11. The method according to claim 1, wherein the fine polymer particles (A) have a graft part that is constituted by a polymer which contains, as one or more structural units, one or more structural units derived from at least one type of monomer selected from the group consisting of aromatic vinyl monomers, vinyl cyanide monomers, and (meth)acrylate monomers.

12. A method for producing a resin composition, comprising, as a step, the method according to claim 5, comprising:
a re-dispersing step of re-dispersing, in an organic solvent (C), the agglutinate that has been separated from the aqueous phase to obtain a dispersion solution; and
a resin mixing step of mixing, with a resin (D), the dispersion solution obtained in the re-dispersing step.

13. The method according to claim 12, wherein the resin (D) is a thermosetting resin.
